(19) United States
(12) Patent Application Publication
(10) Pub. No.: US 2024/0403445 A1
(43) Pub. Date: Dec. 5, 2024

(54) ADVANCED CYBERSECURITY SYSTEMS FOR INFRASTRUCTURE AND NETWORK VULNERABILITY ANALYSIS

(71) Applicants: Jeremy Straub, Fargo, ND (US); Benjamin Clark, Fargo, ND (US); Anthony DeFoe, Fargo, ND (US); Jack Hance, Fargo, ND (US); Danielle Hanson, Fargo, ND (US); Joshua Heeren, Fargo, ND (US); Gavin Kestner, Fargo, ND (US); Cameron Kolodjski, Fargo, ND (US); Jordan Milbrath, Fargo, ND (US); Jonathan M. Rivard, Fargo, ND (US); Dominic Rosch-Grace, Fargo, ND (US); Cayden Schmandt, Fargo, ND (US); Matthew Tassava, West Fargo, ND (US)

(72) Inventors: Jeremy Straub, Fargo, ND (US); Benjamin Clark, Fargo, ND (US); Anthony DeFoe, Fargo, ND (US); Jack Hance, Fargo, ND (US); Danielle Hanson, Fargo, ND (US); Joshua Heeren, Fargo, ND (US); Gavin Kestner, Fargo, ND (US); Cameron Kolodjski, Fargo, ND (US); Jordan Milbrath, Fargo, ND (US); Jonathan M. Rivard, Fargo, ND (US); Dominic Rosch-Grace, Fargo, ND (US); Cayden Schmandt, Fargo, ND (US); Matthew Tassava, West Fargo, ND (US)

(21) Appl. No.: 18/735,155

(22) Filed: Jun. 5, 2024

Related U.S. Application Data
(60) Provisional application No. 63/656,074, filed on Jun. 4, 2024.
(60) Provisional application No. 63/471,214, filed on Jun. 5, 2023.

(51) Int. Cl. G06F 21/57; G06F 11/34; G06F 21/53

(52) U.S. Cl. CPC G06F 21/577; G06F 11/3457; G06F 21/53; G06F 2221/034

(57) ABSTRACT

Advanced cybersecurity systems and methods may provide enhanced security of critical infrastructure without the risks associated with traditional penetration testing. The systems and methods may model network vulnerabilities and simulate attack scenarios to identify potential security breaches. This supports the integration of generic rules and common properties, allowing for dynamic and scalable vulnerability analysis across complex network systems. Additionally, the systems and methods incorporate a multi-purpose fuzzer and an AI-driven Cyber Reasoning System (CRS) that autonomously detects and remedies software vulnerabilities based on predefined logic and pattern recognition. This comprehensive approach identifies existing vulnerabilities and predicts potential future threats by analyzing changes in network behavior and data flow. The systems and methods are particularly suited for mission-critical environments where operational continuity is paramount, providing a robust tool for improved cybersecurity management without disrupting system operations.

### PRIORITY APPLICATION

This application claims priority to U.S. Provisional Patent Application Ser. No. 63/471,214, filed on Jun. 5, 2023, and to U.S. Provisional Patent Application Ser. No. 63/656,074, filed on Jun. 4, 2024, the disclosures of which are incorporated by reference herein in their entirety.

### SUPPORT STATEMENT

Certain features discussed herein were made with government support or were based on previous work made with government support from U.S. Missile Defense Agency contract #HQ0860-22-C-6003 to North Dakota State University. The government may have certain rights in the invention.

### BACKGROUND

Cybersecurity encompasses the protection of computer systems, networks, and data from digital attacks, unauthorized access, and damages. As the digital landscape expands, the complexity and frequency of cyber threats have also increased, making robust cybersecurity measures essential for safeguarding sensitive information and maintaining the integrity of technological infrastructures.

The importance of cybersecurity is underscored by the reliance of modern society on digital systems for a wide range of functions, from personal data storage to the operation of critical national infrastructure. This reliance presents a broad attack surface for malicious actors, including hackers, cybercriminals, and even state-sponsored entities, who may seek to steal, alter, or destroy information or disrupt services.

Cyber threats can take many forms, such as malware, ransomware, phishing, and denial-of-service attacks, each presenting unique challenges and requiring specific strategies for mitigation. The dynamic nature of cyber threats necessitates continuous advancements in cybersecurity technologies and methodologies to detect, prevent, and respond to incidents effectively.

The field of cybersecurity not only involves the development of technological solutions such as firewalls, antivirus software, and encryption protocols but also encompasses the implementation of comprehensive security policies and practices. These include regular system audits, user education and awareness training, and the adoption of best practices for data management and access control.

The development of innovative cybersecurity technologies and frameworks is important for ensuring the resilience and security of systems and networks against a diverse range of cyber threats.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram of a method, according to an embodiment.

FIG. 2 is a block diagram of a method, according to an embodiment.

FIG. 3 is a block diagram of a method, according to an embodiment.

FIG. 4 is a block diagram of a method, according to an embodiment.

FIG. 5 is a block diagram of a method, according to an embodiment.

FIG. 6 is a block diagram of a method, according to an embodiment.

FIG. 7 is a block diagram of a method, according to an embodiment.

FIG. 8 is a block diagram of a method, according to an embodiment.

FIG. 9 is a block diagram of a method, according to an embodiment.

FIG. 10 is a block diagram of a method, according to an embodiment.

FIG. 11 is a block diagram of a method, according to an embodiment.

FIG. 12 is a block diagram of a method, according to an embodiment.

FIG. 13 is a block diagram of a method, according to an embodiment.

FIG. 14 is a block diagram of a method, according to an embodiment.

FIG. 15 is a block diagram of a method, according to an embodiment.

FIG. 16 is a block diagram of a method, according to an embodiment.

FIG. 17 is a block diagram of a method, according to an embodiment.

FIG. 18 is a block diagram of a computing device, according to an embodiment.

### DETAILED DESCRIPTION

Advanced cybersecurity systems and methods may provide enhanced security of critical infrastructure without the risks associated with traditional penetration testing. The systems and methods may model network vulnerabilities and simulate attack scenarios to identify potential security breaches. This supports the integration of generic rules and common properties, allowing for dynamic and scalable vulnerability analysis across complex network systems. Additionally, the systems and methods incorporate a multi-purpose fuzzer and an AI-driven Cyber Reasoning System (CRS) that autonomously detects and remedies software vulnerabilities based on predefined logic and pattern recognition. This comprehensive approach identifies existing vulnerabilities and predicts potential future threats by analyzing changes in network behavior and data flow. The systems and methods are particularly suited for mission-critical environments where operational continuity is important, providing a robust tool for improved cybersecurity management without disrupting system operations.

The Blackboard Architecture builds upon the expert system concept and incorporates rules for assessing and modifying a set of facts. The Blackboard Architecture has found application in various domains such as agent coordination in real-time strategy games, robotics development, medical imaging, counter-terrorism, and software testing. The Blackboard Architecture has been extended with mechanisms for external command execution and has explored modeling attack paths using attack frameworks. A notable feature of the Blackboard Architecture is its flexible logic assessment mechanism, allowing for the addition and removal of knowledge as needed, facilitating self-learning and scalable distributed computation. Expert system-style approaches also offer a higher degree of transparency and explainability compared to algorithms employing machine learning techniques. Any reference herein to Blackboard Architecture or “knowledge-based system” may refer to any collaborative computational model used problem-solving and decision-making domains that uses collaboration among specialized components (e.g., “knowledge sources”) that contribute to solving a complex problem.

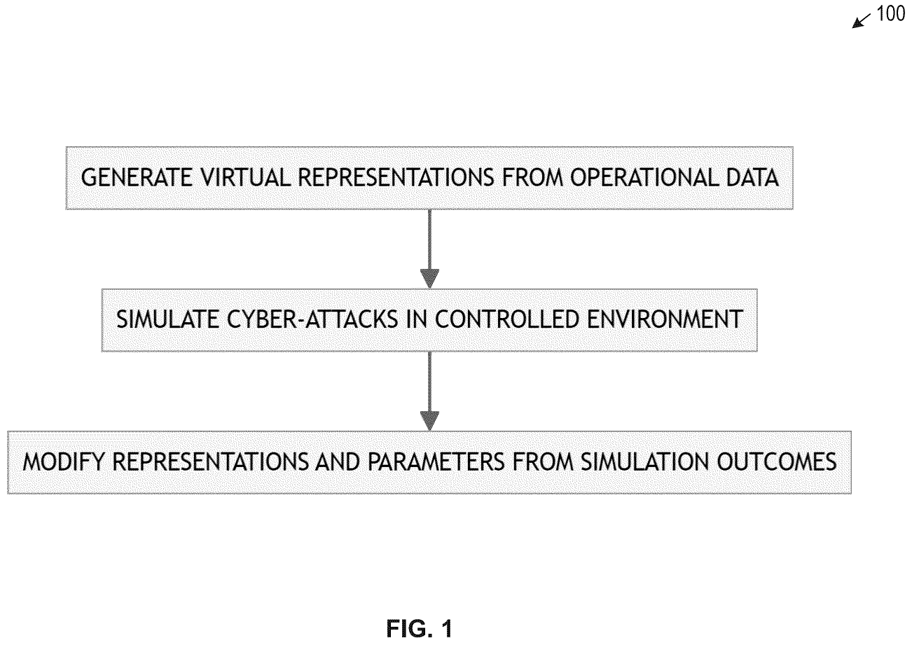

FIG. 1 is a block diagram of method 100, according to an embodiment. Diagram 100 shows a method for conducting cybersecurity assessments on critical infrastructure systems. Initially, virtual representations of the critical infrastructure systems are generated based on operational data. These representations include creating digital twins that are exact replicas of the systems, as well as digital cousins, which are modified versions of the digital twins. Cyber-attacks are then simulated on these virtual representations within a controlled simulation environment, which may be enhanced by quantum computing capabilities and incorporates real-time data feeds to dynamically simulate operational conditions. This environment also supports both manual and automated testing modes.

The simulation of cyber-attacks includes using augmented reality to interact with the virtual representations, providing a more immersive and interactive assessment process. Following the simulations, the virtual representations and simulation parameters are modified based on the outcomes from previous simulations. This modification involves using genetic algorithms to evolve the testing scenarios, thereby enhancing the accuracy and effectiveness of subsequent simulations.

Additionally, the method includes a collaborative platform based on blockchain technology, allowing multiple stakeholders to contribute to the cybersecurity assessments. Artificial intelligence-driven autonomous agents are deployed to conduct independent penetration tests, further enriching the assessment process. The simulation environment may be configured to simulate complex network interactions between multiple virtual representations and to adjust simulation parameters to test various cybersecurity threat levels.

Outcomes from previous simulations are analyzed using machine learning techniques to identify patterns of vulnerabilities, which helps in refining the assessment process. Insights gained from the simulations are used to update the security protocols of the actual critical infrastructure systems. Moreover, the virtual representations are updated iteratively in response to detected vulnerabilities, ensuring that the representations stay relevant and effective for training purposes. Lastly, these virtual representations are used to train cybersecurity personnel in threat detection and response, enhancing their skills and preparedness for real-world scenarios.

A system designed for conducting cybersecurity assessments on critical infrastructure systems includes several integral components. At the core of the system is a processor that may be specifically configured to generate virtual representations based on operational data from the critical infrastructure systems. These virtual representations include digital twins, which are exact replicas of the systems, and digital cousins, which are modified versions of these twins to provide varied testing scenarios.

The system also features a simulation environment that may be operatively coupled to the processor. This environment may be configured to simulate cyber-attacks on the virtual representations without impacting the physical operational systems. Augmented reality may be utilized within this simulation environment to enhance the interaction and realism of the simulations. Additionally, the simulation environment may be supported by quantum computing, which significantly enhances its processing capabilities.

An iterative feedback device is another component of the system. This device may be configured to modify the virtual representations and simulation parameters based on outcomes from previous simulations, using genetic algorithms to evolve the testing scenarios effectively. This allows for continuous improvement in simulation accuracy and effectiveness.

The system further includes a blockchain-based collaborative platform, enabling multiple stakeholders to securely contribute to the cybersecurity assessments. AI-driven autonomous agents are also integrated into the system to conduct independent and thorough penetration tests.

Real-time data feeds are incorporated into the simulation environment to ensure that the simulations reflect current operational conditions accurately. The processor may be capable of updating the security protocols of the actual critical infrastructure systems based on insights gained from the simulations. Additionally, the virtual representations are updated iteratively in response to detected vulnerabilities, ensuring they remain current and effective for ongoing assessments.

The simulation environment may be designed to simulate complex network interactions between multiple virtual representations and allows for the adjustment of simulation parameters to test various cybersecurity threat levels. Outcomes from the simulations are analyzed using advanced machine learning techniques to identify patterns of vulnerabilities, further refining the assessment process.

Lastly, the simulation environment supports both manual and automated testing modes, providing flexibility in how tests are conducted. The virtual representations generated by the system are also used for training purposes, helping to educate and prepare cybersecurity personnel in threat detection and response. This comprehensive system ensures a robust approach to securing critical infrastructure against potential cyber threats.

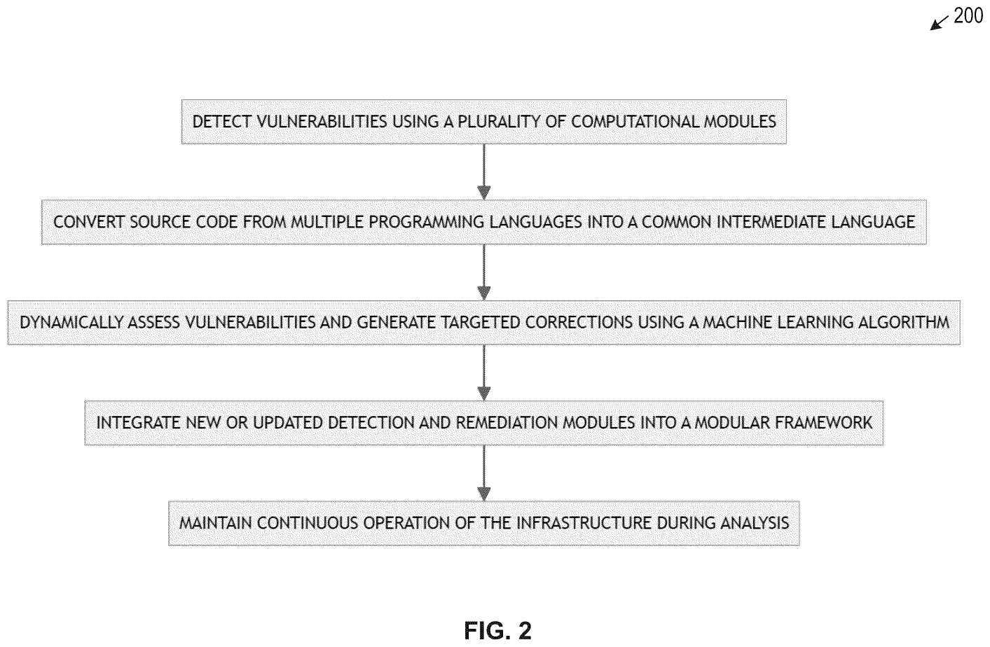

FIG. 2 is a block diagram of method 200, according to an embodiment. Diagram 200 shows a method for identifying vulnerabilities and defects in source code that involves several key steps. Initially, the process begins with the detection of vulnerabilities using a plurality of computational devices. These devices are designed to scan and analyze the source code from one or more programming languages. Following detection, the source code may be converted into a common intermediate language. This standardization allows for a more uniform analysis across different programming languages. Once the source code is in a common intermediate language, it undergoes a thorough analysis. During this phase, the method leverages a machine learning algorithm to perform several critical functions. These functions include identifying vulnerabilities within the code, generating targeted corrections to address these vulnerabilities, and applying these corrections back to the original source code. Additionally, the machine learning algorithm is used to identify specific vulnerable areas within the original source code. This comprehensive approach ensures that the source code is not only analyzed for existing vulnerabilities but also enhanced to prevent future issues.

A similar method may include detecting vulnerabilities using a plurality of computational devices. The source code from multiple programming languages is then converted into a common intermediate language, specifically C, to maintain uniformity. This conversion preserves the logical flow and structure of the original source code, ensuring that the essence of the original programming is retained.

The method dynamically assesses vulnerabilities and generates targeted corrections using a machine learning algorithm, which includes employing generative AI to locate and correct vulnerabilities effectively. These corrections and updates are integrated into a modular framework, which allows for the seamless integration of additional devices as needed. All modifications are meticulously recorded on a blockchain ledger, enhancing the security and traceability of the process.

The system is designed to maintain the continuous operation of the infrastructure during the analysis, ensuring that critical operations are not disrupted. This method is optimized based on feedback from system performance and external intelligence, making the process adaptive and responsive to emerging threats.

Implemented on a cloud infrastructure, the method benefits from scalability and remote management capabilities. It allows for manual overrides through a user interface, providing flexibility and control to system administrators. The system generates alerts and reports on security threats and actions, keeping stakeholders informed.

The method supports multiple programming languages, including object-oriented, scripting, and procedural languages, and enhances processing capabilities with quantum computing elements. It also includes the deployment of autonomous mobile units for monitoring, and decisions are implemented based on outputs from optimization algorithms.

Furthermore, the method operates in hybrid environments, accommodating both on-premises and cloud components. It detects anomalies in network behavior as potential security threats, adding an additional layer of security. Finally, all detected threats and actions are archived for future analysis, providing a valuable resource for ongoing security enhancement and research.

A system designed for the real-time identification and remediation of software vulnerabilities across multiple programming languages in critical infrastructure includes several sophisticated components. It features a plurality of computational devices that autonomously detect, analyze, and respond to software vulnerabilities. These devices work in conjunction with a conversion mechanism that standardizes source code from diverse programming languages into a common intermediate language, specifically C. This conversion mechanism includes both a compiler and a decompiler that preserve the logical flow and structure of the original source code.

The system employs a machine learning algorithm, executed by at least one device, to dynamically assess potential vulnerabilities and autonomously generate targeted corrections. This algorithm utilizes generative AI techniques to precisely locate and correct vulnerabilities and continuously optimizes detection and remediation processes based on system performance data and external threat intelligence.

A modular framework within the system supports the dynamic integration of new or updated vulnerability detection and remediation devices. This framework facilitates seamless integration of additional devices without causing system downtime. Additionally, all modifications are recorded on a blockchain ledger, ensuring the traceability and integrity of changes.

Implemented on a cloud infrastructure, the system enhances scalability and enables remote management. It includes a user interface that allows manual intervention in decision-making processes and is configured to generate comprehensive alerts and reports regarding security threats and remediation actions.

The system supports conversion from various programming languages, including object-oriented, scripting, and procedural languages. It incorporates quantum computing elements to augment processing capabilities and includes autonomous mobile units equipped with the cybersecurity system for enhanced monitoring. Decisions within the system are implemented based on outputs from an optimization algorithm, and all detected threats and remedial actions are archived for subsequent analysis.

Designed to operate in hybrid environments, the system combines on-premises and cloud components and features an anomaly detection device that identifies atypical network behaviors as potential threats. This comprehensive system ensures robust cybersecurity management across critical infrastructure.

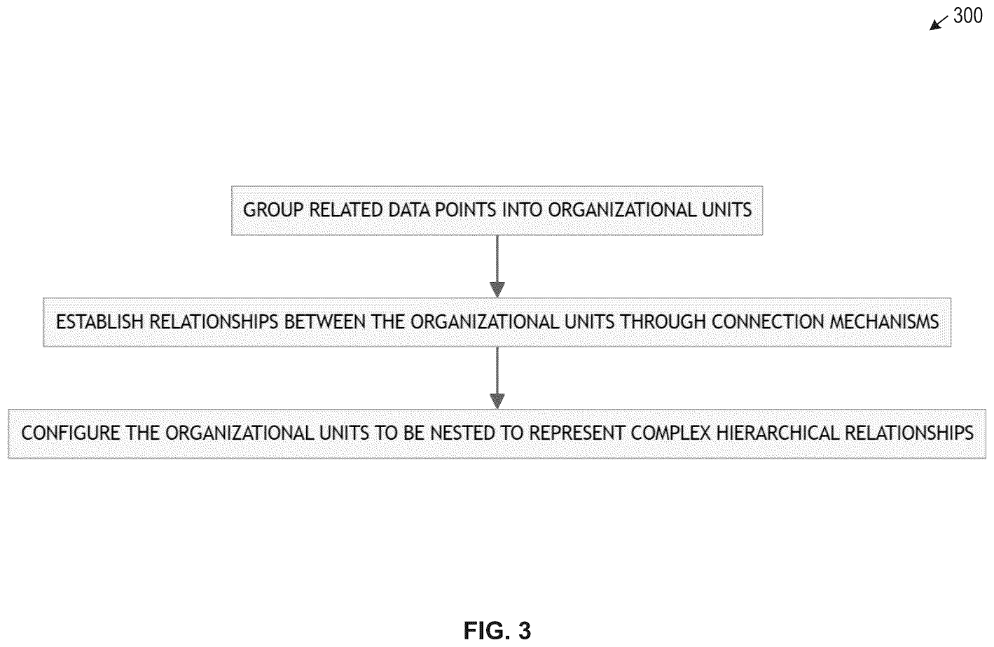

FIG. 3 is a block diagram of method 300, according to an embodiment. Diagram 300 shows a method for identifying vulnerabilities and defects in source code involves a comprehensive approach utilizing several key techniques. Initially, vulnerabilities are detected using a plurality of computational devices designed to scan and analyze the code. Following this, the source code, which may originate from one or more programming languages, is converted into a common intermediate language. This standardization facilitates a more uniform analysis process.

Once in a common intermediate language, the source code undergoes further analysis to pinpoint specific vulnerabilities and defects. This analysis can leverage a machine learning algorithm, which is capable of not only identifying vulnerabilities but also generating targeted corrections. These corrections can then be applied back to the original source code, ensuring that the fixes are integrated seamlessly into the existing codebase. Additionally, the machine learning algorithm may be used to identify particularly vulnerable areas within the original source code, allowing for targeted preemptive measures to enhance code security and integrity. This method provides a robust framework for improving software quality and security through advanced computational and machine learning techniques.

A similar method for real-time identification and remediation of software vulnerabilities in critical infrastructure involves several key steps to ensure the security and continuous operation of the system. The process begins with the detection of vulnerabilities using a plurality of computational devices. These devices analyze the source code, which is converted from multiple programming languages into a common intermediate language, specifically C, to standardize the analysis process.

The method utilizes a machine learning algorithm to dynamically assess vulnerabilities and generate targeted corrections. This algorithm is capable of employing generative AI techniques to precisely locate and correct vulnerabilities. The system is designed with a modular framework that allows for the seamless integration of new or updated detection and remediation devices, ensuring the system remains up-to-date with the latest security protocols.

Throughout the analysis and remediation process, the infrastructure maintains continuous operation, preventing downtime and ensuring that critical functions are not disrupted. All modifications made during the remediation process are recorded on a blockchain ledger, which enhances the traceability and integrity of changes.

The method optimizes detection and remediation processes based on feedback from system performance data and external threat intelligence. It is implemented on a cloud infrastructure to leverage scalability and enable remote management. Additionally, the system allows for manual overrides through a user interface, which provides flexibility in handling complex security threats.

The system is capable of generating detailed alerts and reports on security threats and remedial actions taken. It supports multiple programming languages, including object-oriented, scripting, and procedural languages, and enhances processing capabilities with quantum computing elements. Furthermore, the method includes deploying autonomous mobile units equipped with the cybersecurity system for enhanced monitoring.

Decisions within the system are implemented based on outputs from an optimization algorithm, ensuring efficient and effective responses to detected threats. All detected threats and remedial actions are archived for future analysis, providing valuable insights for improving security measures. The method is designed to operate in hybrid environments, combining on-premises and cloud components, and includes an anomaly detection device that identifies atypical network behaviors as potential security threats. This comprehensive approach ensures robust protection against vulnerabilities in critical infrastructure.

A system for real-time identification and remediation of software vulnerabilities across multiple programming languages in critical infrastructure comprises several integral components. It includes a plurality of computational devices configured to autonomously detect, analyze, and respond to software vulnerabilities. A conversion mechanism standardizes source code from diverse programming languages into a common intermediate language, specifically C, ensuring uniformity in processing.

The system employs a machine learning algorithm, executed by at least one device, to dynamically assess potential vulnerabilities and autonomously generate targeted corrections. This algorithm utilizes generative AI techniques to precisely locate and correct vulnerabilities. The system is built on a modular framework that supports dynamic integration of new or updated vulnerability detection and remediation devices, facilitating seamless integration of additional devices without system downtime.

Key features of the system include a blockchain ledger to record all modifications, ensuring traceability and integrity of changes. The machine learning algorithm optimizes detection and remediation processes based on continuous learning from system performance data and external threat intelligence. The system is implemented on a cloud infrastructure to enhance scalability and enable remote management.

Additionally, the system includes a user interface that allows manual intervention in decision-making processes. It is configured to generate comprehensive alerts and reports regarding security threats and remediation actions. The system supports conversion from object-oriented, scripting, and procedural programming languages and incorporates quantum computing elements to augment processing capabilities.

Further enhancing its capabilities, the system includes autonomous mobile units equipped with the cybersecurity system for enhanced monitoring. Decisions within the system are implemented based on outputs from an optimization algorithm. All detected threats and remedial actions are archived for subsequent analysis. Designed to operate in hybrid environments, the system combines on-premises and cloud components and features an anomaly detection device that identifies atypical network behaviors as potential threats. This comprehensive system ensures robust protection and continuous operation of critical infrastructure during cybersecurity analysis.

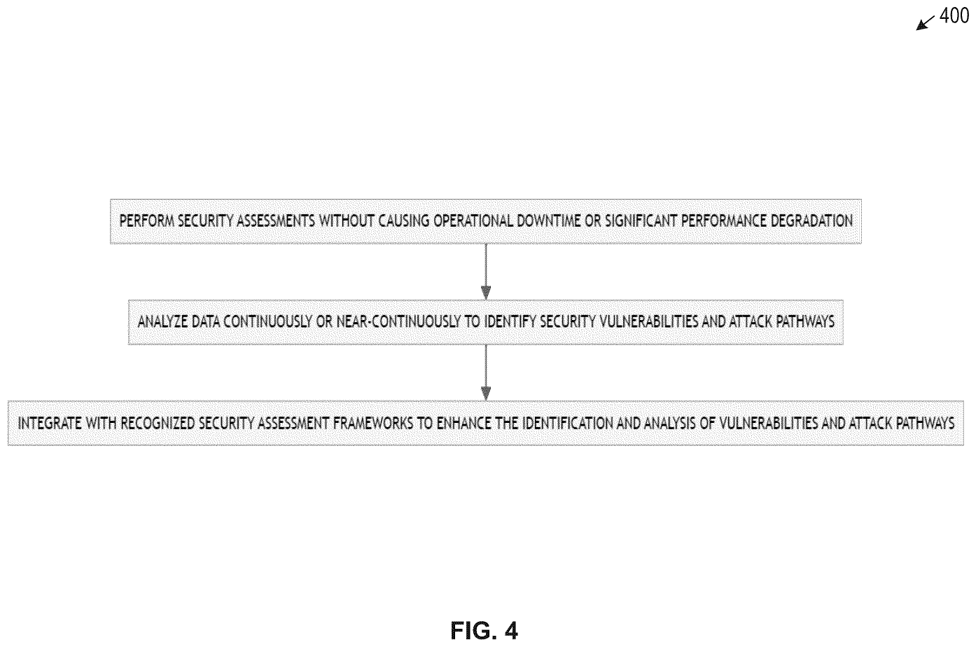

FIG. 4 is a block diagram of method 400, according to an embodiment. Diagram 400 shows a method for conducting security assessments on complex mission critical systems (CMCS) includes several key components designed to ensure thorough and efficient security evaluations without disrupting system operations. The method involves performing security assessments that do not cause operational downtime or significant performance degradation, often maintaining system performance impact to less than 5% degradation. It includes incremental testing of system components to ensure detailed scrutiny without overwhelming the system.

Data is analyzed continuously or near-continuously, utilizing real-time data processing to identify security vulnerabilities and attack pathways, with results available within seconds of data acquisition. This method integrates with recognized security assessment frameworks, such as the MITRE ATT&CK model and the Lockheed Martin Cyber Kill Chain, ensuring compatibility and the ability to automatically update to adapt to changes in these frameworks.

Further enhancements to the method include displaying the results of the security assessments through a user interface, which may employ augmented reality to visualize vulnerabilities and attack pathways. The method also involves employing a distributed network of microservices, each configured to monitor and analyze specific segments of the CMCS, enhancing the granularity and responsiveness of the security assessment.

All actions taken during the assessment are logged in an immutable blockchain ledger, ensuring the integrity and traceability of the security data. Predictive analytics are employed, using an artificial intelligence device to forecast future vulnerabilities based on historical data analysis. Additionally, the method leverages a quantum computing device to enhance data processing speed and efficiency.

The method is implemented in a cloud computing environment, allowing for scalability and remote management. It also includes a mechanism for adjusting the security assessment process based on feedback from previous assessments, ensuring continuous improvement. Recommendations for mitigating identified vulnerabilities are provided based on the analysis, aiding in the improved fortification of the system against potential threats.

A system designed for conducting security assessments on complex mission critical systems (CMCS) includes a storage device and processing circuitry. This system is engineered to perform security assessments without causing operational downtime or significant performance degradation, ensuring minimal impact on system performance, specifically less than 5% degradation. It is capable of analyzing data continuously or near-continuously to swiftly identify security vulnerabilities and attack pathways, providing results within seconds of data acquisition.

The processing circuitry is configured to integrate with recognized security assessment frameworks, including compatibility with frameworks such as the MITRE ATT&CK model and the Lockheed Martin Cyber Kill Chain. This integration is supported by automatic update devices that ensure the system remains current with framework changes.

The system includes various specialized devices to enhance its functionality. Incremental testing devices facilitate detailed security assessments, while real-time data processing devices support the continuous analysis capability. A user interface device, which can employ augmented reality, displays the results of the security assessments, offering an intuitive and interactive visualization of data.

Additionally, the system architecture incorporates a distributed network of microservices, enhancing its scalability and responsiveness. A blockchain device logs all actions taken during the assessments, ensuring data integrity and traceability. An artificial intelligence device predicts future vulnerabilities based on historical data, allowing for improved security measures.

For enhanced data processing capabilities, a quantum computing device is included, significantly boosting the processing speed and efficiency. The system also features a device for providing specific mitigation recommendations based on the assessment results.

Implemented in a cloud computing environment, the system benefits from high scalability and remote management capabilities. It also includes a feedback device that adjusts the security assessment process based on insights gained from previous assessments, promoting continuous improvement in security practices. This comprehensive system provides a robust solution for securing complex mission critical systems against emerging threats.

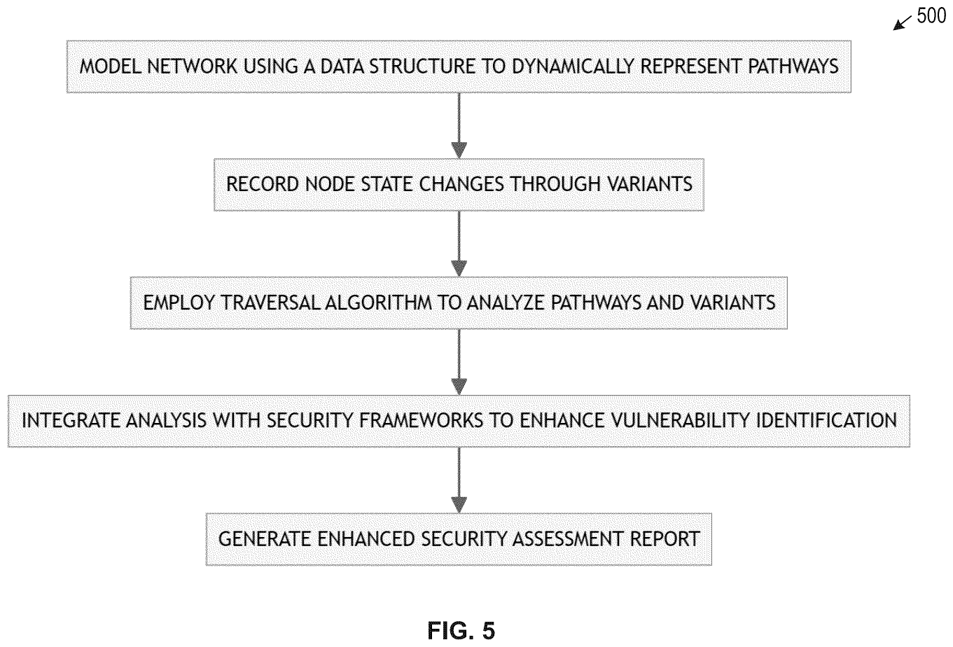

FIG. 5 is a block diagram of method 500, according to an embodiment. Diagram 500 shows a method for providing a plurality of rule, fact, and property objects, which encompasses several functionalities related to alternate objects. Each alternate object represents different configurations of the original object under various conditions. The method facilitates the provision of alternate objects that represent another configuration of the original object, including those that depict changes at different times in the processing sequence and under different network configurations. Additionally, some alternate objects are stored as paths that detail the modifications made to the network, outlining the changes made to the network or recording the order of object changes. This includes alternate objects that represent configurations at different times in processing or under different network configurations, where the objects are stored as paths that indicate how changes to the network were implemented. The method also includes providing alternate objects identified as the most recent versions, enhancing the method's ability to dynamically adapt and comprehensively document evolving configurations of the network over time and under varying conditions.

A similar method for conducting security assessments on computer networks involves several interconnected processes. Initially, the network is modeled using a data structure that dynamically represents potential pathways through the network, with each pathway indicative of a sequence of states the network may undergo during potential or actual attack scenarios. Changes in the states of network nodes are recorded through variants, where each variant captures different possible states of a node under varying conditions.

To analyze these pathways and variants, a traversal algorithm is employed, which is designed to identify all possible attack paths and associated vulnerabilities. This analysis is further integrated with security assessment frameworks to enhance the identification of vulnerabilities. The data structure used for modeling the network is termed as reality paths, which store detailed sequences of states and facts encountered along each path in the network.

The traversal algorithm is configured to systematically explore every potential pathway, adjusting dynamically to real-time changes in the network. Additionally, the integration with security assessment frameworks includes adapting the analysis based on updates within these frameworks. The method is implemented on a distributed computing platform to utilize enhanced processing capabilities and scalability.

Further enhancing the method, each identified pathway and state variation is logged using blockchain technology to ensure data integrity and provide an audit trail. The security assessments are configured to run continuously or near-continuously without causing significant performance degradation to the network. A user interface is also provided, offering a visual representation of the reality paths and variants for interactive exploration. This interface may utilize virtual reality technology to facilitate an immersive exploration experience.

Artificial intelligence is employed within the method to predict future vulnerabilities based on historical data and current network behavior. Provisions are included to minimize operational downtime during security assessments. The variants are specifically configured to track temporal changes in network node states, and the reality paths include provisions for incorporating external data sources to enhance the accuracy of the pathway modeling.

The traversal algorithm includes heuristic components to optimize the path exploration process, and the security assessment frameworks are customizable according to specific network requirements. Finally, the method includes mechanisms for alert generation based on identified vulnerabilities, ensuring timely responses to potential security threats.

The apparatus designed for conducting security assessments on computer networks comprises a processor configured to execute software instructions and a memory that stores these instructions. When executed by the processor, these instructions facilitate several critical functions. The primary function involves modeling the network using a data structure that dynamically represents potential pathways through the network. Additionally, the apparatus records changes in the states of network nodes through variants and employs a traversal algorithm to analyze these pathways and variants. The analysis is further integrated with security assessment frameworks to enhance the identification of vulnerabilities.

The data structure used in this apparatus comprises reality paths that store sequences of states and facts encountered along each path in the network. The traversal algorithm is specifically configured to dynamically adjust to real-time changes in the network, ensuring that the security assessments remain accurate and timely. Furthermore, the integration with security assessment frameworks is designed to adapt based on updates within these frameworks, maintaining the relevance and effectiveness of the security assessments.

To enhance its processing capabilities, the apparatus includes a distributed computing device. It also features a blockchain device for logging each identified pathway and state variation, ensuring the integrity and traceability of the data. The processor is configured to perform continuous or near-continuous security assessments, minimizing the impact on network performance and avoiding significant downtime.

For user interaction and data visualization, the apparatus includes a display configured to provide a visual representation of the reality paths and variants. This display supports virtual reality output, offering an immersive experience that can help in understanding complex network interactions and vulnerabilities more intuitively.

Additionally, the apparatus is equipped with an artificial intelligence device designed to predict future vulnerabilities based on historical data and current network behavior. This improved feature helps in anticipating potential security threats before they manifest. The apparatus is also configured to minimize operational downtime during assessments, ensuring that security monitoring does not disrupt normal network operations.

The variants within the apparatus are configured to track temporal changes in network node states, and the reality paths incorporate external data sources to enhance the accuracy of the pathway modeling. The traversal algorithm includes heuristic components to optimize the path exploration process, making the assessments more efficient. The security assessment frameworks are customizable according to specific network requirements, allowing for tailored security solutions.

Finally, the apparatus includes an alert generation device that is activated based on identified vulnerabilities, enabling timely responses to potential security threats. This comprehensive setup ensures that the apparatus not only identifies and analyzes vulnerabilities effectively but also enhances the overall security posture of the network it monitors.

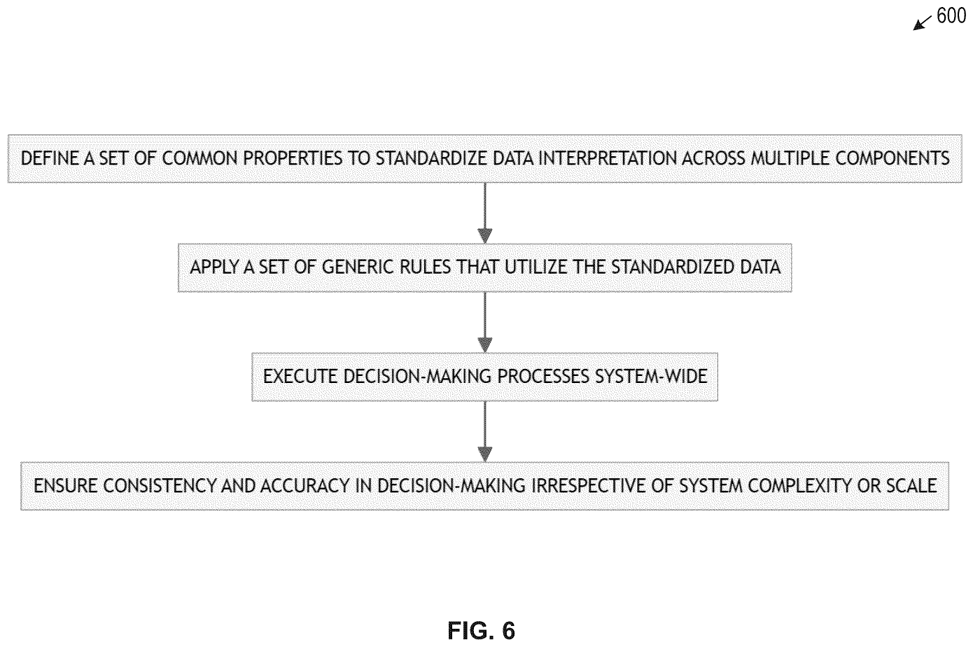

FIG. 6 is a block diagram of method 600, according to an embodiment. Diagram 600 shows a method that involves providing a plurality of rule, fact, and property objects, which includes several specific actions to enhance the functionality and efficiency of an object network. Firstly, the method includes defining a set of common properties to standardize aspects such as data interpretation, data use, or data manipulation across multiple components of the network. These common properties are identified by a unique common property identifier, ensuring that they are easily recognizable and uniformly applied across the system.

Additionally, facts are defined and associated with a common property identifier to indicate that they belong to the common property type. This association helps in maintaining consistency and relevance of data throughout the network. The method also involves defining a set of generic rules that utilize these standardized objects and common properties as either their inputs or outputs, facilitating flexible and dynamic decision-making processes.

Moreover, the method includes defining environment facts that can be universally used throughout the network, providing a foundational layer of data that supports various operations. Rules are also defined that can alter the value of a plurality of facts or all facts of a common property type, enhancing the adaptability of the system to changing conditions or requirements.

Finally, the method allows for the reuse of rules and properties throughout the network, promoting efficiency and reducing redundancy. This reuse capability ensures that once a rule or property is defined, it can be applied in multiple scenarios or components within the network without the need for redefinition, streamlining the operational processes and decision-making within the system.

A similar method for managing decision-making processes in a knowledge-based system (e.g., Blackboard Architecture system) involves several key steps to enhance system-wide operations. Initially, the method includes defining a set of common properties to standardize data interpretation across multiple components of the system. These common properties are specifically defined for each category of data or object within the system, ensuring uniformity and clarity in data handling.

Following the establishment of common properties, a set of generic rules is applied. These rules utilize the standardized data to execute decision-making processes across the entire system. The generic rules are designed to be applicable to any link or connection between components that meet predefined criteria based on the common properties. Moreover, these rules are capable of dynamically adapting to changes in data or operational conditions, ensuring that decision-making remains relevant and effective regardless of system complexity or scale.

To enhance accountability and traceability, all decisions and rule applications are recorded in a blockchain ledger. Additionally, the application of generic rules is optimized using a neural network that analyzes historical data to improve decision-making efficiency.

The method also incorporates an augmented reality interface to facilitate real-time interaction with the system, providing a more intuitive and engaging user experience. In scenarios requiring extensive data processing, quantum computing is employed to handle real-time data processing and rule application, significantly enhancing processing speed and capacity.

Autonomous agents are utilized within the system to manage subsets of system components. These agents autonomously apply generic rules, promoting decentralized management and faster response times. The method is implemented in a cloud computing environment to leverage enhanced scalability and resource availability.

A feedback mechanism is included to refine common properties and generic rules based on their effectiveness, ensuring continuous improvement of the decision-making process. The application of generic rules is carefully managed to minimize impact on system performance, maintaining system efficiency even during complex operations.

Real-time notifications and updates on decision-making outcomes are provided to keep system operators informed and responsive. Lastly, the user interface offers actionable recommendations based on rule outcomes, aiding users in making informed decisions based on the system's analysis and suggestions. This comprehensive approach not only standardizes data interpretation by aligning data attributes to a common format but also ensures that the system's decision-making processes are robust, accurate, and adaptable to varying conditions.

The system designed for managing decision-making processes in a Blackboard Architecture includes a comprehensive set of components that enhance its functionality and efficiency. At its core, the system features a device dedicated to defining common properties, which standardizes data interpretation across the entire system. This device ensures uniform data handling by defining properties for each data category and aligning data attributes to a standard format.

Additionally, a device for applying generic rules utilizes the standardized data to execute decision-making processes. This device is adept at applying rules to connections that meet specific criteria and dynamically adapts to data and operational changes, ensuring that decision-making remains relevant and effective under varying conditions.

A control unit within the system oversees the overall operation, maintaining high standards of decision quality and system reliability. To enhance the system's capabilities, it includes a blockchain ledger that records all decisions and rule applications, providing a secure and immutable record that enhances transparency and accountability. A neural network optimizes the application of generic rules by analyzing historical data to improve efficiency and effectiveness.

The system also features an augmented reality interface that facilitates real-time interaction, offering an immersive and intuitive user experience. Autonomous agents are employed to manage and apply rules to system components autonomously, promoting decentralized control and faster response times. A quantum computing device significantly enhances the system's computational power for advanced processing and rule application.

Implemented in a cloud environment, the system leverages enhanced scalability and resource availability to accommodate growing demands. A feedback mechanism allows for the continuous refinement of properties and rules based on their effectiveness, ensuring the system evolves to meet changing needs. The generic rules device is designed to minimize the impact on system performance, ensuring that the system remains efficient even as it handles complex tasks.

Real-time notifications and updates keep system users informed of ongoing processes and outcomes, while a user interface offers actionable recommendations based on rule outcomes, aiding users in making informed decisions based on the system's analysis. This comprehensive system not only streamlines decision-making processes but also ensures that these processes are robust, accurate, and adaptable to the dynamic requirements of a Blackboard Architecture environment.

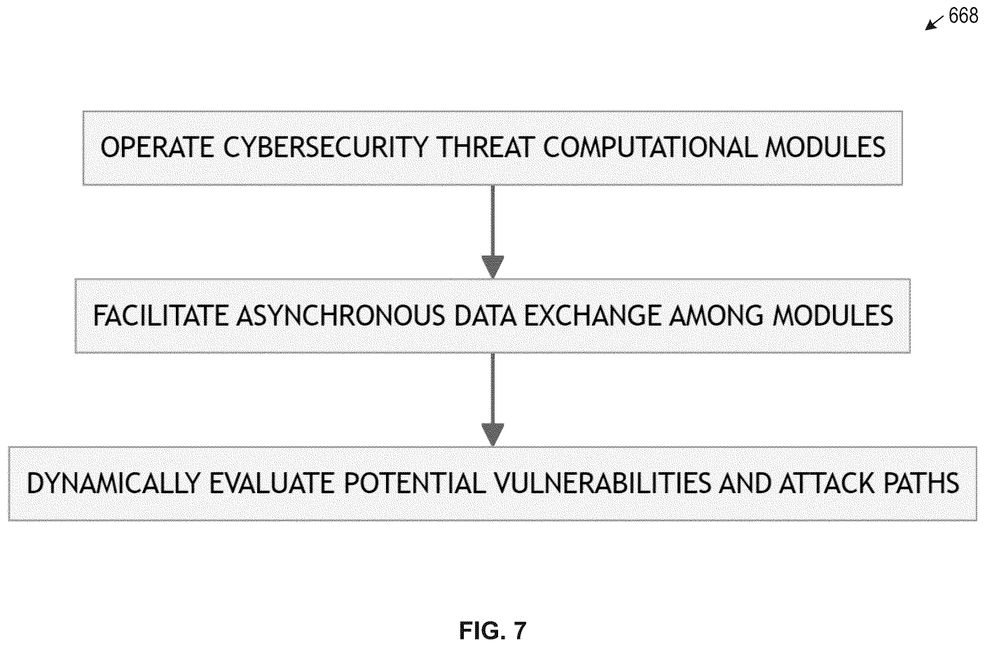

FIG. 7 is a block diagram of method 668, according to an embodiment. Diagram 668 shows a method that involves operating a plurality of computational devices designed to detect and analyze cybersecurity threats. These devices operate autonomously, enabling them to not only detect and analyze but also respond to cybersecurity threats effectively. The operation of these devices includes the facilitation of data exchange among them via a communication network, enhancing the coordination and efficiency of threat analysis. Additionally, at least one of these devices is equipped to execute a search algorithm, such as an iterative deepening search algorithm, which is utilized to evaluate potential vulnerabilities and attack paths systematically. Importantly, the method ensures that the continuous operation of the infrastructure is maintained during the cybersecurity analysis, thereby preventing any disruption to system functionality while enhancing security measures.

A similar method provides real-time cybersecurity analysis of mission-critical infrastructure includes several key components. It operates a plurality of computational devices autonomously to detect, analyze, and respond to cybersecurity threats. These devices facilitate asynchronous data exchange via a communication network without centralized coordination and execute an iterative deepening search algorithm to dynamically evaluate potential vulnerabilities and attack paths. Importantly, the method ensures the continuous operation of the infrastructure during the cybersecurity analysis.

Further enhancements to this method include managing data exchange among modules through a blackboard architecture and utilizing a peer-to-peer communication protocol for decentralized data sharing. The iterative deepening search algorithm is adapted based on real-time input of threat data, and security status updates and alerts are displayed through a graphical user interface. Each device employs machine learning to enhance its threat detection and response capabilities.

The method is implemented across cloud infrastructure to enable scalable analysis across multiple sites and includes the use of a mobile application for remote monitoring and control by authorized users. It also limits resource usage to a predefined threshold to maintain operational functionality and incorporates elements of quantum computing to improve the efficiency of the search algorithm.

Additionally, the method involves autonomous mobile units equipped with the cybersecurity analysis system for surveillance purposes and integrates a biological neural network interface to detect potential threats based on electrical signal patterns. It includes automatic updating of security protocols in response to detected threats and archives detected threats and responses for subsequent analysis and learning.

The method is executed in a hybrid environment combining on-premises and cloud-based system components and includes detecting anomalies in network behavior as potential security threats. These comprehensive features ensure robust, real-time cybersecurity analysis tailored to protect mission-critical infrastructure effectively.

The system for real-time cybersecurity analysis of mission-critical infrastructure encompasses several integral components. It consists of a plurality of computational modules that are configured to operate autonomously to detect, analyze, and respond to cybersecurity threats. These modules are interconnected through a communication network that facilitates asynchronous data exchange without centralized coordination. An iterative deepening search algorithm is executed by at least one of the modules to dynamically evaluate potential vulnerabilities and attack paths. Importantly, the system is designed to ensure the continuous operation of the infrastructure during the cybersecurity analysis.

Additional features of this system include the use of a blackboard architecture within the communication network to enhance data sharing among the modules. Alternatively, the network may employ a peer-to-peer protocol allowing for decentralized data sharing. The iterative deepening search algorithm is capable of adjusting its operations based on real-time input of threat data. Moreover, the system includes a graphical user interface that displays security status updates and alerts in real-time.

Each device within the system utilizes machine learning algorithms to continuously refine its threat detection and response processes. The system is implemented on cloud infrastructure, which provides scalable cybersecurity analysis capabilities across geographically dispersed infrastructure sites. It also integrates a mobile application for remote monitoring and control by authorized personnel.

To maintain operational functionality during intensive analysis, the system limits its resource usage to a predefined threshold. It incorporates elements of quantum computing to enhance the processing capabilities of the iterative deepening search algorithm. Additionally, the system may include autonomous mobile units equipped with the cybersecurity analysis system for both physical and network infrastructure surveillance.

A biological neural network interface is integrated to detect unusual electrical signal patterns as indicators of potential cybersecurity threats. The modules are configured to automatically update security protocols in response to detected threats. Furthermore, the system archives all detected threats and responses for future analysis and learning.

The system is configured to operate in a hybrid environment that combines both on-premises and cloud-based components. It also includes an anomaly detection feature that identifies deviations from typical network behavior as potential security threats, enhancing the overall security posture of the infrastructure.

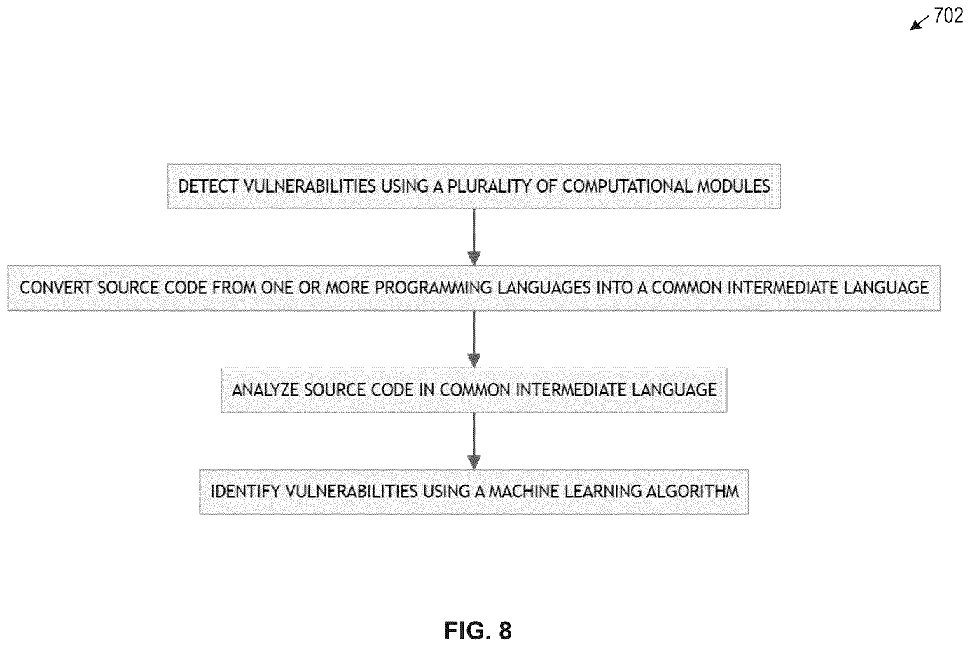

FIG. 8 is a block diagram of method 702, according to an embodiment. Diagram 702 shows a method for identifying vulnerabilities and defects in source code encompasses several key steps to ensure thorough analysis and remediation. Initially, the method involves detecting vulnerabilities using a plurality of computational modules, which are designed to scan and identify potential issues across various programming environments. Following this detection phase, the source code from one or more programming languages is converted into a common intermediate language. This standardization facilitates a more uniform analysis process.

Once the source code is in a common intermediate language, it undergoes a detailed analysis to further identify vulnerabilities. This analysis can lead to several potential actions, depending on the findings. These actions include identifying additional vulnerabilities using a machine learning algorithm, which can recognize patterns and anomalies that may not be evident through standard procedural checks. Additionally, the method can generate targeted corrections using a machine learning algorithm, which not only identifies the issues but also suggests precise remedial measures.

Furthermore, the method allows for the application of these targeted corrections back to the original source code, ensuring that the fixes are implemented in the environment where the code will ultimately operate. Alternatively, the method can involve identifying specific vulnerable areas directly within the original source code, allowing for targeted manual or automated intervention. This comprehensive approach ensures that vulnerabilities are not only detected but also rectified, enhancing the security and integrity of the software.

A similar method for real-time identification and remediation of software vulnerabilities in critical infrastructure includes several comprehensive steps designed to enhance the security and functionality of the system. Initially, the method involves detecting vulnerabilities using a plurality of computational modules. Following detection, the source code from multiple programming languages is converted into a common intermediate language, which is specified as C in one of the claims. This conversion preserves the logical flow and structure of the original source code, ensuring that the essence of the code is maintained.

The method dynamically assesses vulnerabilities and generates targeted corrections using a machine learning algorithm. This process is supported by the use of generative AI to locate and correct vulnerabilities effectively. New or updated detection and remediation modules are integrated into a modular framework, which allows for seamless addition of additional modules as needed.

The system is designed to maintain continuous operation of the infrastructure during the analysis, ensuring that critical operations are not disrupted. Modifications made during the process are recorded on a blockchain ledger, providing a secure and immutable record of all actions taken. The method also includes a feedback loop, optimizing detection and remediation processes based on system performance and external intelligence.

Implemented on a cloud infrastructure, the method supports scalability and remote management. It allows for manual overrides through a user interface and generates alerts and reports on security threats and actions taken. The system supports multiple programming languages, including object-oriented, scripting, and procedural languages, and enhances processing capabilities with quantum computing elements.

Additionally, the method involves deploying autonomous mobile units for monitoring and implements decisions based on outputs from an optimization algorithm. All detected threats and actions are archived for future analysis. The system is capable of operating in hybrid environments that combine on-premises and cloud components and detects anomalies in network behavior as potential security threats. This comprehensive approach ensures robust security measures are in place to protect critical infrastructure effectively.

The system for real-time identification and remediation of software vulnerabilities across multiple programming languages in critical infrastructure is designed to enhance cybersecurity measures effectively. It comprises a plurality of computational modules that autonomously detect, analyze, and respond to software vulnerabilities. These modules utilize a conversion mechanism to standardize source code from diverse programming languages into a common intermediate language, specifically C, to facilitate uniform analysis.

The system includes a machine learning algorithm, executed by at least one device, which dynamically assesses potential vulnerabilities and autonomously generates targeted corrections. This algorithm employs generative AI techniques to precisely locate and correct vulnerabilities. The system is structured around a modular framework that supports the dynamic integration of new or updated vulnerability detection and remediation modules, allowing for seamless integration of additional modules without system downtime.

Continuous operation of the infrastructure is maintained during the cybersecurity analysis, ensuring that critical operations are not disrupted. All modifications made by the system are recorded on a blockchain ledger, enhancing the traceability and integrity of changes. The machine learning algorithm continuously optimizes detection and remediation processes based on system performance data and external threat intelligence.

Implemented on a cloud infrastructure, the system offers enhanced scalability and enables remote management. It includes a user interface that allows manual intervention in decision-making processes and is configured to generate comprehensive alerts and reports regarding security threats and remediation actions. The system supports conversion from various programming languages, including object-oriented, scripting, and procedural languages.

Additionally, the system incorporates quantum computing elements to augment processing capabilities and includes autonomous mobile units equipped with the cybersecurity system for enhanced monitoring. Decisions within the system are implemented based on outputs from an optimization algorithm, and all detected threats and remedial actions are archived for subsequent analysis.

Designed to operate in hybrid environments, the system combines on-premises and cloud components and features an anomaly detection device that identifies atypical network behaviors as potential threats. This comprehensive system ensures robust protection against software vulnerabilities in critical infrastructure.

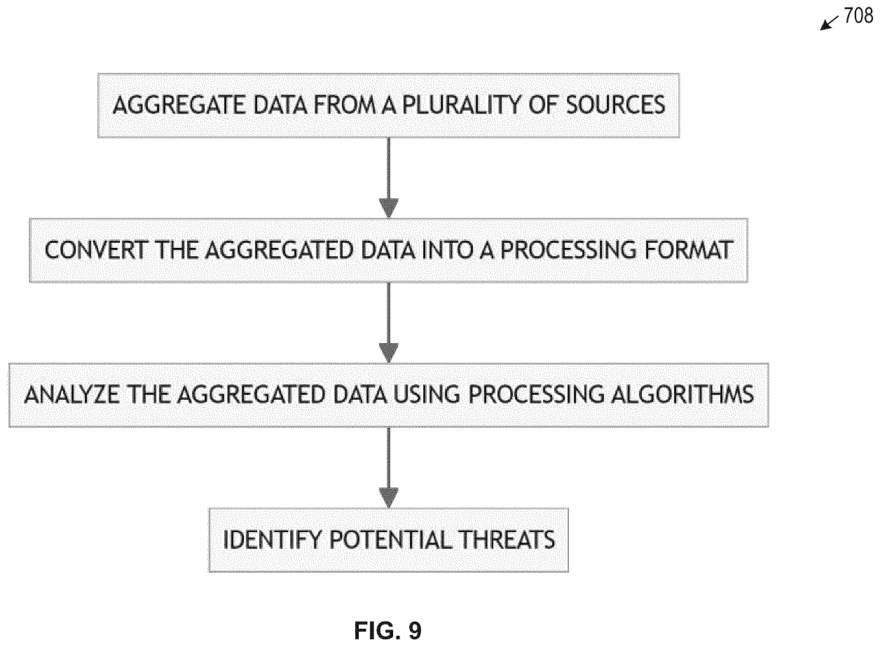

FIG. 9 is a block diagram of method 708, according to an embodiment. Diagram 708 shows a method for identifying and managing potential threats within an organization involves a comprehensive process that starts by aggregating data from a variety of sources. These sources may include, but are not limited to, information related to an organization's employees, contractors, vendor staff, volunteers, affiliates' workforce, family members, associates, communications, activities, interactions, and influences pertaining to the workforce. Once the data is collected, it is converted into a processing format suitable for detailed analysis.

The aggregated data is then analyzed using sophisticated processing algorithms specifically designed to identify potential threats. Based on this analysis, risk scores are calculated to quantify the level of threat each identified risk poses to the organization. These risk scores serve as a basis for implementing or recommending security measures tailored to mitigate the identified risks effectively.

The method includes a dynamic component where both the risk scores and the security measures are continuously updated in real-time. This real-time update is based on new data inputs, ensuring that the organization's security posture is adaptive and responsive to evolving threats. This ongoing adjustment allows for improved management of security risks, ensuring that the organization can maintain an increased level of security by addressing potential threats promptly and efficiently.

A similar method for managing security risks in an organization includes a comprehensive approach that begins with the aggregation of data from multiple sources, including social media, surveillance systems, and internal operational databases. Once collected, this data is standardized into a uniform format, potentially using generative AI to convert unstructured data into structured data, ensuring consistency across different types of information.

The standardized data is then analyzed using advanced processing algorithms, such as machine learning and generative AI, to identify potential threats. Based on this analysis, risk scores are dynamically calculated and updated at intervals not exceeding one hour. These risk scores inform the implementation of security measures, which may include adjustments to physical security infrastructure, access controls, and alert systems. The security measures are adapted in real-time based on ongoing data inputs, allowing for responsive adjustments to the organization's security posture.

Additionally, the method includes predictive modeling to anticipate future threat scenarios based on historical data trends. This improved approach helps in preparing the organization against potential future risks. A user interface is provided for manual oversight and adjustments, ensuring that human judgment can complement automated processes.

The entire system is implemented using cloud computing technology, which enhances scalability and facilitates remote management. Blockchain technology is employed within the data aggregation process to ensure the integrity of the data collected. Further, a neural network is utilized within the risk assessment process to improve the accuracy and efficiency of threat detection.

Anomaly detection is incorporated to identify deviations from normal data patterns, which helps in recognizing subtle signs of potential threats. In cases of high-risk scores, the system automatically initiates emergency protocols. The system is designed to integrate seamlessly with the existing security infrastructure of the organization, enhancing rather than replacing current security measures.

Lastly, all personal data is processed in an anonymized manner to maintain privacy compliance, ensuring that the organization's security measures do not compromise the privacy rights of individuals. This comprehensive method provides a robust framework for managing security risks effectively within an organization.

The system for improved risk management in an organization is designed to enhance security through a series of interconnected modules that work together to identify and mitigate threats. The system includes a data integration device, which aggregates and standardizes diverse data types from multiple sources such as social media content, surveillance footage, and operational data from internal databases. This device utilizes generative AI to convert unstructured data into a structured format suitable for analysis.

An analysis device employs advanced data processing algorithms, including machine learning models and generative AI techniques, to evaluate the standardized data for potential security threats. This device also includes capabilities for predictive threat modeling based on trend analysis, enhancing the system's ability to forecast potential risks.

The risk assessment device dynamically calculates and updates risk scores at predefined intervals not exceeding one hour. This device incorporates a deep learning network to refine the accuracy of threat detection, ensuring that the organization is alerted to potential risks in a timely manner.

A security management device implements predefined security measures based on the risk scores. These measures include automatic adjustments to access controls and the sending of alerts in response to changes in risk scores. The device is also configured to initiate emergency protocols automatically in response to critical risk alerts and extends its functionality to include modifications to physical security settings.

The entire system updates the risk scores and adapts security measures in response to real-time data inputs. It includes a user interface that provides notifications of risk score changes and allows for manual intervention, ensuring that users can respond to alerts and adjust settings as needed.

Implemented on a cloud infrastructure, the system facilitates scalability and remote access. It employs blockchain technology within the data integration device for enhanced data security and traceability, ensuring that all data handling is secure and accountable. Additionally, the system includes an anomaly detection mechanism that flags unusual data patterns as potential risks.

Designed to integrate seamlessly with existing organizational security systems, the system ensures that it complements and enhances current security measures without requiring extensive modifications. Furthermore, all personal data is processed in an anonymized format to ensure compliance with privacy laws, safeguarding the privacy of individuals while maintaining a high level of security.

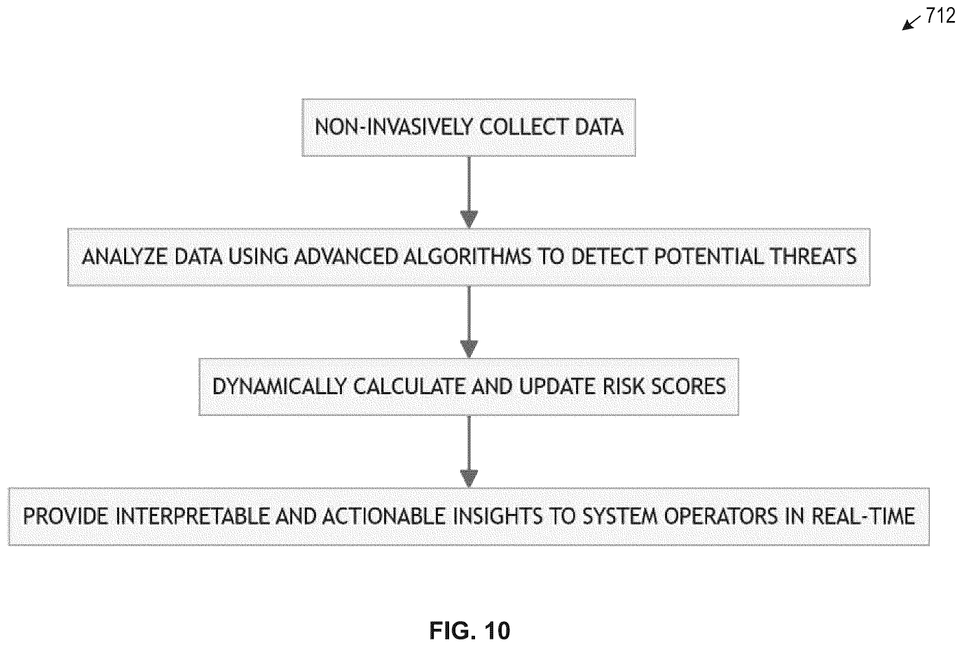

FIG. 10 is a block diagram of method 712, according to an embodiment. Diagram 712 shows a method that involves a series of steps for managing and assessing security within various systems, which may include operational technology systems, functional technology systems, information technology systems, hybrid systems, or other systems. The initial step in the method includes at least one of the following: non-invasively collecting data from these systems, utilizing previously collected data, or providing an interface for a user to manually enter data. Once the data is gathered, it is analyzed using algorithms designed to detect potential threats, actual threats, or vulnerabilities within the systems. Following the analysis, the method includes at least one action from the following options: calculating risk scores, updating risk scores, identifying vulnerabilities, identifying risks, identifying potential attack paths, or providing actionable insights to system operators based on the results of the analysis. This comprehensive approach ensures a robust security assessment and management process tailored to the specific needs and configurations of various technological systems.

A similar method may be used for managing security vulnerabilities in critical systems, specifically targeting information technology (IT), operational technology (OT), and functional technology (FT) systems. The method involves non-invasively collecting data from these systems, which can be achieved via network interfaces or sensors without necessitating physical interaction with the systems. Once collected, the data is analyzed using advanced algorithms, including machine learning algorithms that adapt based on new data inputs, to detect potential threats. This analysis facilitates the dynamic calculation and real-time or near-real-time updating of risk scores.

Further, the method enhances the utility of the generated data by providing interpretable and actionable insights to system operators in real-time, utilizing explainable AI techniques to improve the clarity and usability of these insights. A user interface is included to allow manual adjustments and to manage alerts, thereby enhancing interactive capabilities and responsiveness.

Additionally, the method integrates external threat intelligence data to enrich the data collection process and employs simulation of attack scenarios to provide improved identification of vulnerabilities. Customization options are available, allowing adaptation of system modules to meet specific organizational needs. For scalability and effective management, the method is implemented on a cloud platform.

Anomaly detection is utilized to identify unusual operational patterns, and a neural network is incorporated within the risk assessment process to enhance the accuracy of the evaluations. The method is designed to automatically initiate response protocols based on the assessed risk levels and integrates seamlessly with existing security infrastructure. To ensure privacy compliance, data is processed in an anonymized format. Lastly, the method supports the generation of periodic reports that provide insights into security status and trends, aiding in strategic decision-making and continuous improvement of security measures.

A corresponding system is designed for improved vulnerability management in critical systems, encompassing a comprehensive suite of modules tailored for enhanced security operations. The system includes a data acquisition device, which is configured to non-invasively collect operational data from a combination of information technology (IT), operational technology (OT), and functional technology (FT) systems. This device can gather data through network interfaces or sensors that do not physically interact with the systems, ensuring minimal disruption.

An analysis device within the system employs advanced algorithms, including adaptive machine learning models, to evaluate the collected data for potential security threats. This device is capable of simulating attack scenarios to provide improved identification of potential vulnerabilities and includes an anomaly detection component that flags unusual patterns as potential threats.

The risk assessment device of the system dynamically calculates and updates risk scores in real-time or near-real-time, incorporating a neural network to improve prediction accuracy. Based on these risk assessments, a communication device provides interpretable and actionable insights to system operators in real-time. This device utilizes explainable AI (XAI) techniques to ensure that the insights are easily understandable and automatically triggers response protocols based on the severity of the risk.

Further enhancing its functionality, the system includes a user interface that allows operators to manually adjust settings and respond to alerts. The data acquisition device also integrates data from external threat intelligence feeds, enriching the context for more accurate threat detection.

The architecture of the system is modular, allowing for customization according to specific organizational requirements. It is implemented on a cloud platform to enhance scalability and facilitate remote management, ensuring that the system can be efficiently operated from various locations. Additionally, the system is designed to integrate seamlessly with existing security infrastructure, providing a cohesive security management experience.

To ensure compliance with privacy laws, all data within the system is processed in an anonymized manner. The system is also configured to generate periodic security reports that detail the status and trends, aiding in strategic decision-making and ongoing security assessments.

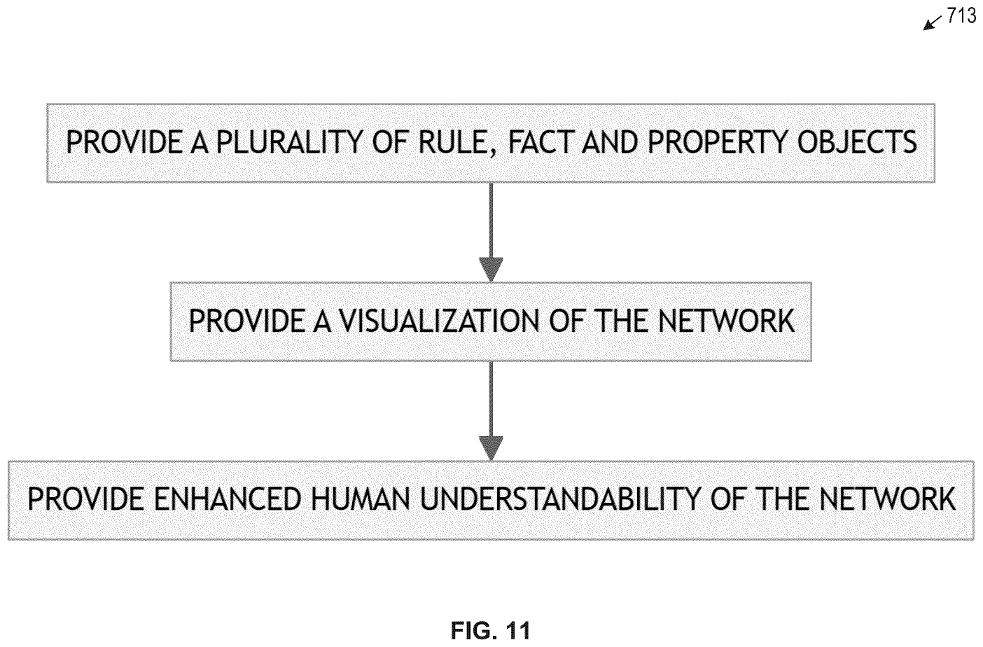

FIG. 11 is a block diagram of method 713, according to an embodiment. Diagram 713 shows a method that provides a comprehensive approach to network visualization and analysis. This method involves providing a plurality of rule, fact, and property objects that define and contextualize the network's operational parameters. Central to this method is the provision of a network visualization, which is designed to enhance the interpretability and usability of network data.

The visualization includes various features aimed at improving the clarity and depth of network analysis. These features include the coloration of network components to indicate various statuses such as operational state, the number of traversals of each component, or other relevant attributes. Additionally, the method incorporates labeling, marking, and identification of network components to facilitate easy recognition and understanding of different parts of the network. The visual organization of network components can also be altered to optimize the display according to specific analysis needs.

Furthermore, the visualization created through this method can be preserved in several formats for various uses. It can be saved as a graphics file, a vector file, or a hypertext markup file, depending on the requirements for further processing or presentation. The visualization can also be printed directly, allowing for physical copies to be used for reports, presentations, or further analysis.

The capabilities of this method extend to enhancing human understandability of the network, which is crucial for operators and analysts who need to make quick and informed decisions. It aids in the identification of network features, limitations, anomalies, changes, and vulnerabilities. Additionally, the method supports the identification of processing requirements, network speed, attack speed, and deviations from standard operational parameters. Overall, this method provides a robust toolset for detailed and dynamic visualization of network data, significantly aiding in the management, troubleshooting, and enhancement of network operations.

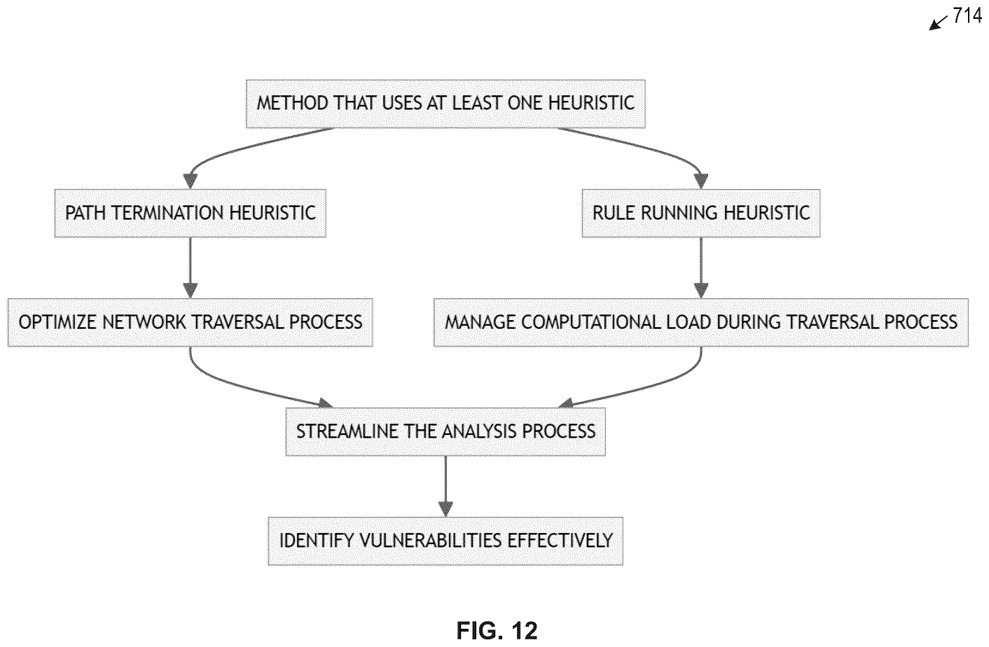

FIG. 12 is a block diagram of method 714, according to an embodiment. Diagram 714 shows a method that uses at least one heuristic. This heuristic may include a path termination heuristic that stops processing when an identified condition is met, or may include a rule running heuristic that stops processing when a specified number of rules have been run. The path termination heuristic is designed to optimize the network traversal process by terminating a path if the current connection, along with its resulting fact-rule evaluation, has previously been established within that path. This approach prevents the system from redundantly reprocessing paths that have already been evaluated, thereby saving computational resources and enhancing the system's overall efficiency.

Additionally, the rule-running heuristic plays a crucial role in managing the computational load during the traversal process. It limits the number of generic rules that can be triggered for each connection by using a user-defined integer value as a cap. This heuristic ensures that the system remains efficient and responsive, even as the complexity of the network increases, by focusing on the most relevant rules and avoiding an overload of computations.

Together, these heuristics are instrumental in streamlining the analysis process, allowing the system to deliver timely and accurate vulnerability assessments. They help manage the complexity inherent in large and intricate network environments, ensuring that the system can effectively identify vulnerabilities without being overwhelmed by the extensive data and potential network configurations.

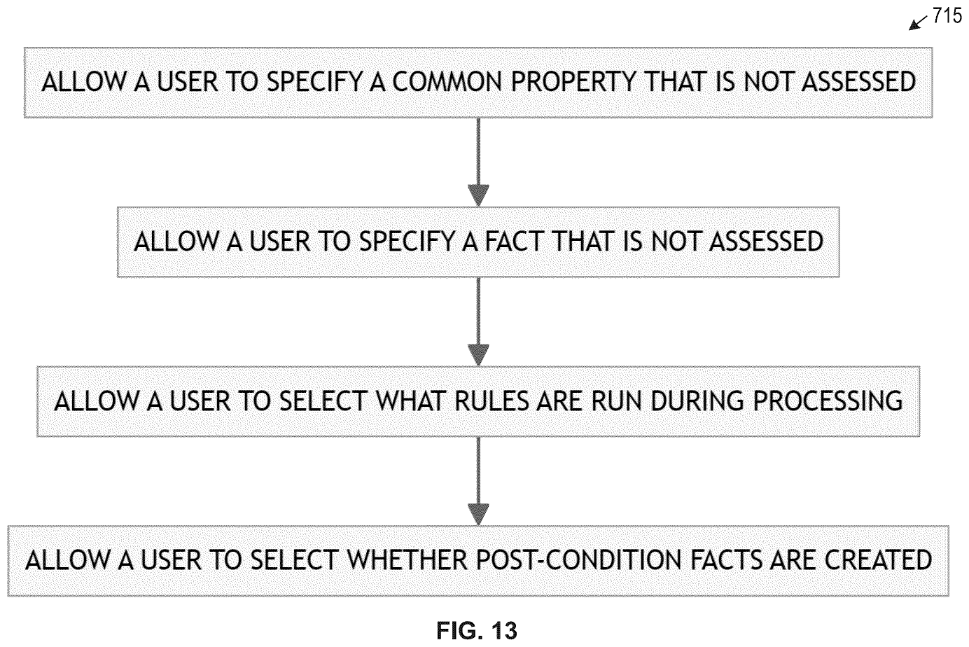

FIG. 13 is a block diagram of method 715, according to an embodiment. Diagram 715 shows a method that includes incorporating several user-defined functions to enhance the flexibility and specificity of the processing system. Firstly, the method incorporates a function that allows a user to specify a common property that is not assessed during the analysis. Additionally, it includes a function that enables a user to specify that a common property should not be assessed if it is found to be missing during the processing phase.

Furthermore, the method incorporates a function that allows a user to specify a fact that is not assessed. This is complemented by another function that enables the user to specify that a fact should not be assessed if it is missing during the processing, ensuring that the system can handle incomplete data gracefully.

The method also includes a function that allows a user to select specific rules that are run during the processing. This allows for tailored analysis based on the user's requirements or the specificities of the dataset being processed.

Lastly, the method incorporates a function that enables a user to select whether post-condition facts are created during the processing. This feature provides users with control over the generation of output data, allowing for customized results based on the user's needs or preferences. Together, these functions provide significant control and customization of the processing, enhancing the system's utility and adaptability.

A corresponding system includes several advanced features that allow users to customize and control the analysis process effectively. Firstly, the system is equipped with a feature that permits users to specify a common property that should not be assessed. This capability ensures that users can exclude certain properties from the analysis based on specific criteria or relevance to the current analysis scenario.

Additionally, the system is designed to accommodate scenarios where certain data elements might be missing. It includes a feature that allows users to specify that a common property should not be assessed if it is found to be missing during the processing. This ensures that the system remains robust and can handle incomplete datasets without compromising the integrity of the analysis.

The system also provides a feature that enables users to specify a fact that is not assessed during the analysis. This is particularly useful for focusing the analysis on relevant facts and excluding those that do not contribute to the objective of the analysis. Complementing this, there is a feature that allows for the exclusion of a fact from assessment if it is missing during the processing, enhancing the system's flexibility in dealing with incomplete information.

To further tailor the analysis process, the system includes a feature that allows users to select specific rules to be run during the processing. This selective rule execution enables users to adapt the analysis to specific needs or to experiment with different analytical approaches.

Lastly, the system incorporates a feature that enables users to decide whether post-condition facts are created during the processing. This control over the output allows users to manage the results generated by the system, ensuring that the output aligns with their specific requirements or analysis goals.

Together, these features make the system highly adaptable and user-friendly, providing significant control over the analysis process and ensuring that the system can be effectively used in a variety of different scenarios and applications.

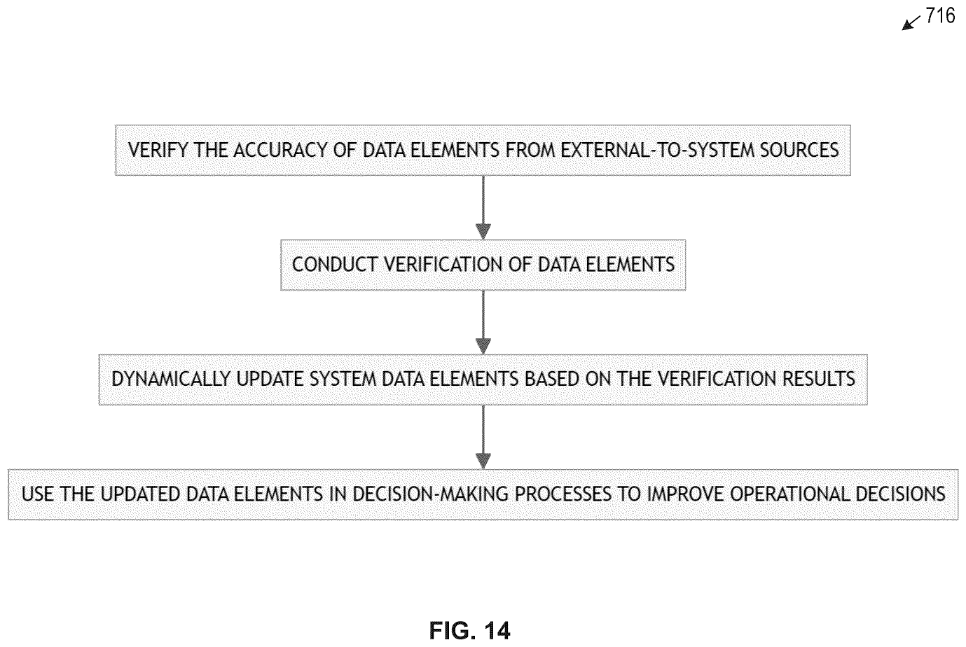

FIG. 14 is a block diagram of method 716, according to an embodiment. Diagram 716 shows a method for improving decision-making through a comprehensive approach to data verification and updating. It begins by verifying the accuracy of data elements sourced from external systems. This verification process ensures that the data used in subsequent operations is reliable and accurate. Following the verification, the method involves dynamically updating the system's data elements based on the results of this verification. This ensures that the system operates with the most current and validated data available.

Further, the updated data elements are then utilized in decision-making processes to enhance the quality and effectiveness of operational decisions. This integration of verified data into decision-making processes helps in making more informed, accurate, and timely decisions.

Additionally, the method includes conducting verification of data elements based on specific criteria such as access to the data element, elapsed time since the last verification, lack of previous verification, the frequency of data access, expiration of the data element, or other triggers that necessitate a re-verification. This aspect of the method ensures ongoing accuracy and relevance of the data, thereby supporting sustained operational efficiency and decision-making accuracy.

A similar method includes improving decision-making in software systems through real-time data verification and updating. This method involves verifying the accuracy of data from external sources within a critical timeframe, dynamically updating system data based on the verification results, and utilizing the updated data in decision-making processes to improve operational decisions.

Further details of the method include continuous monitoring of data streams to verify data, and the immediate integration of verified data into system operations for dynamic updating. Additionally, data updates are integrated in real-time into the decision-making process to ensure timely and effective operational responses.

The verification process employs machine learning techniques to adapt verification methods based on historical data accuracy. The updating process prioritizes data based on predefined criteria that focus on system security and stability. The method also allows for manual adjustments in decisions through a user interface, providing users with real-time data insights for more informed decision-making.

Data verification accommodates various formats and sources without the need for standardization. Before verification, the security level of the data is assessed to ensure its integrity. The method is implemented on a cloud computing infrastructure, leveraging distributed data processing capabilities.

Feedback mechanisms are included to enhance data reliability by providing insights back to external data sources. Updates are securely logged using blockchain technology to maintain data integrity. Predictive analytics are employed to simulate potential decision outcomes based on the updated data, providing foresight into possible future scenarios.

Automatic alerts are generated when updates significantly impact system operations, ensuring immediate attention to critical changes. Anomaly detection is included to prevent the verification of inaccurate data, enhancing the reliability of the system. Lastly, the method generates comprehensive reports that detail the effects of data updates on decision-making, providing a clear view of the impact and effectiveness of the system enhancements.

A corresponding system provides real-time data verification and updating to enhance decision-making processes. It consists of three main components: a data verification device configured to assess the accuracy of data from multiple external sources within a critical timeframe, a data updating device that dynamically integrates verified data into the system's operational databases, and a decision-making device that utilizes the dynamically updated data to enhance operational decisions.

Further details of the system include the data verification device operating continuously to ensure data relevance and accuracy. The data updating device is designed to update the operational data immediately following verification, ensuring timely integration of critical data. The decision-making device integrates these updates in real-time to directly influence decision outcomes.

The data verification device employs adaptive learning algorithms to enhance the verification processes over time, improving its efficiency and accuracy with continued use. The data updating device prioritizes updates based on their impact on system stability and security, ensuring that critical updates are processed first. Additionally, the system includes a user interface that allows operators to manually adjust the decision-making process based on the updated data, providing flexibility and control.

The data verification device supports verification from diverse data formats and sources, enhancing its versatility. A security assessment device is included to evaluate the security level of incoming data before it undergoes verification, ensuring that only secure data is processed. The system is implemented on a distributed computing platform, facilitating scalability and robust data handling.

Feedback mechanisms within the data verification device enhance data accuracy by providing insights back to the data sources. The data updating device uses blockchain technology to log updates securely, maintaining a high level of data integrity. The decision-making device employs predictive analytics to forecast potential outcomes based on the updated data, providing foresight into possible future scenarios.

The system is configured to issue automated alerts when critical updates affect system operations, ensuring immediate attention to significant changes. The data verification device includes anomaly detection capabilities to identify and address data discrepancies, enhancing the reliability of the data processed. Lastly, the system includes a reporting device that generates detailed reports on the impact of data updates on decisions, providing comprehensive insights into the effectiveness of the system enhancements.

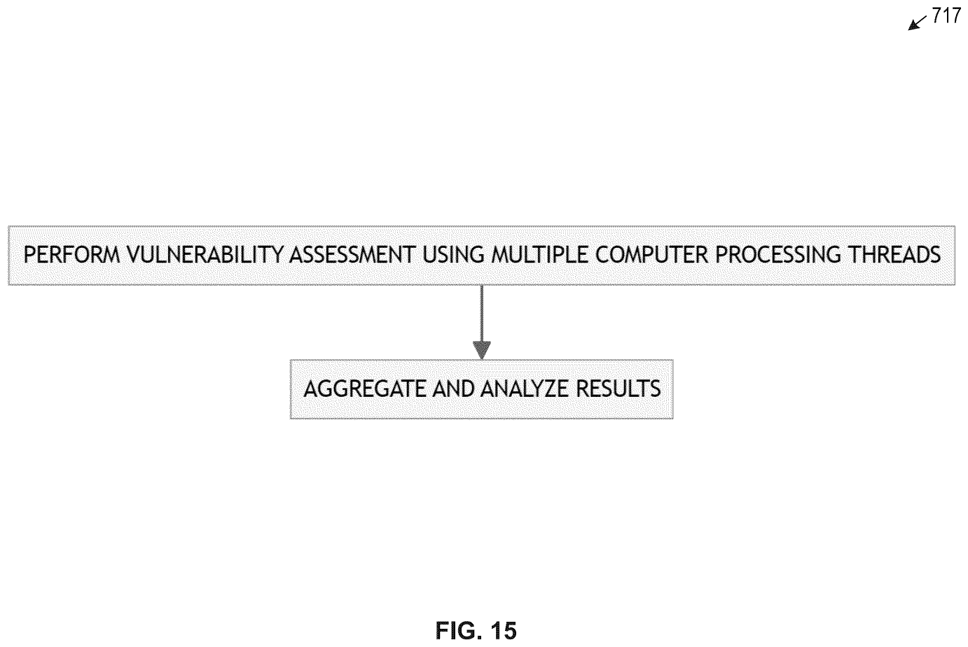

FIG. 15 is a block diagram of method 717, according to an embodiment. Diagram 717 shows a method that uses multiple computer processing threads to perform analysis, leveraging the capabilities of modern computing architectures to enhance efficiency and effectiveness. This approach includes using at least one of the following configurations: synchronous or asynchronous communications between processors, employing two or more processing threads within the same physical processor, utilizing two or more processors located within the same computer system, or incorporating processors located within two or more computer systems. Additionally, the method encompasses network communications between two or more computing systems and includes mechanisms for error correction of network communications. This multifaceted approach allows for a robust and flexible analysis process, capable of handling complex data and computational demands across various computing environments.

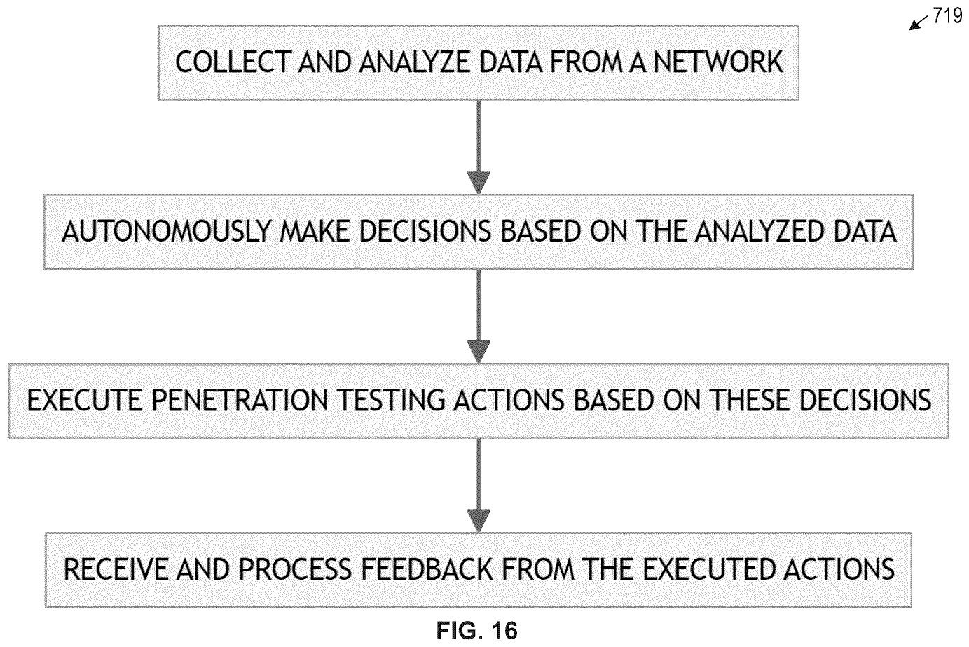

FIG. 16 is a block diagram of method 719, according to an embodiment. Diagram 719 shows a method for performing automated penetration testing of network systems, incorporating a comprehensive and dynamic approach. Initially, the method involves collecting and analyzing data from a network to gather essential insights. Based on this analyzed data, the system autonomously makes informed decisions that guide the subsequent steps of the penetration testing process.

Following the decision-making phase, the method executes specific penetration testing actions that are directly influenced by the earlier decisions. After these actions are executed, the system is designed to receive and process feedback from these actions in real-time or near real-time. This feedback is crucial as it informs the system of the outcomes and effectiveness of the testing actions.

Building on the feedback received, the method may undertake one or more of the following steps: making security recommendations to a user, correcting identified vulnerabilities, or taking targeted actions based on the feedback to enhance the identification, mapping, or exploitation of vulnerabilities. Additionally, the system may adjust subsequent penetration testing activities based on the insights gained, ensuring a continually improving and adapting testing process. This method ensures a thorough and responsive approach to network security, enhancing protective measures and system resilience.

A similar method for automated penetration testing of network systems includes a series of interconnected and dynamic processes. Initially, the method involves dynamically collecting and analyzing data from a network. Based on this data, decisions are autonomously made using an architectural framework, specifically a Blackboard Architecture, which is further integrated with a software tool known as SONARR (Software for Operations and Network Attack Results Review).

Following the decision-making process, the method executes penetration testing actions influenced by these decisions. Feedback from these actions is received and processed in real-time through a verifier device. This device is capable of validating or updating data points in the network and adapts to various types of network information, including port scans and system logs.

Subsequent penetration testing actions are adjusted based on the feedback to enhance the identification, mapping, and exploitation of vulnerabilities. This adjustment process involves scaling the penetration testing to accommodate different network sizes and configurations, utilizing modular components adaptable to various network environments.

The decision-making device employs machine learning algorithms to predict potential vulnerabilities and selects network nodes and paths for testing based on vulnerability scores. The method is implemented through a cloud-based service, allowing users to upload network configurations for testing. The entire process of data collection, analysis, and feedback processing is performed in a continuous iterative loop.

Feedback includes results of attempted exploits and their success rates, and adjustments to testing actions are based on changes in network configuration detected through continuous monitoring. The architectural framework processes commands and controls distributed across multiple network points. Penetration testing actions may include simulating attacks on virtual replicas of network segments, and the feedback mechanism utilizes artificial intelligence to analyze outcomes and suggest modifications. This comprehensive method ensures a thorough and adaptive approach to network security testing.

A corresponding system provides automated penetration testing of network systems, incorporating several sophisticated modules to enhance security analysis. The system includes a data analysis device configured to dynamically collect and analyze data from a network. This device works in conjunction with a decision-making device that utilizes an architectural framework, specifically a Blackboard Architecture employing a rule-fact-action paradigm, to facilitate autonomous decision-making based on the analyzed data.

A real-time feedback mechanism is integral to the system, configured to receive and process feedback from actions performed within the network. This mechanism includes a verifier device that validates or updates the values of data points in the network after each action is executed. The verifier device is adaptable and can incorporate various types of network information and feedback, such as port scans, system logs, and real-time network traffic data.

The system is designed with a modular architecture that allows for scalability and adaptability in various network environments, including cloud-based, on-premise, and hybrid networks. These modular components are interchangeable, catering to different network configurations and testing scenarios. Additionally, the decision-making device employs machine learning algorithms to predict potential vulnerabilities based on historical data and current network analysis.

Implemented as a cloud-based service, the system allows users to upload their network configurations for remote penetration testing. The data analysis device, decision-making device, and real-time feedback mechanism operate in a continuous loop, providing ongoing and iterative penetration testing. This setup automates the identification, mapping, and exploitation of vulnerabilities in the network, enhancing the efficiency and effectiveness of penetration testing.

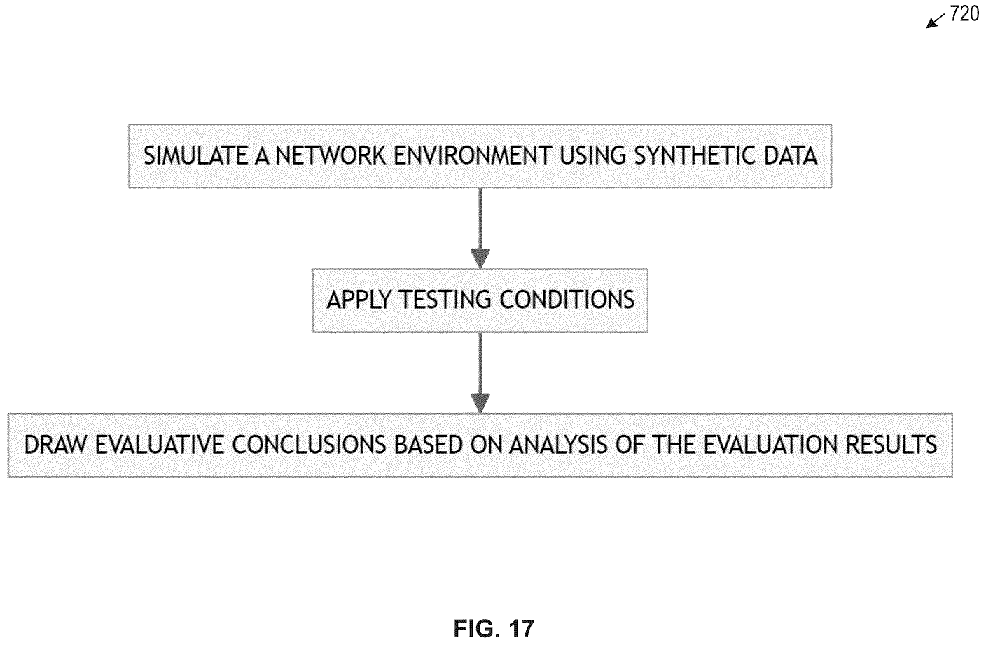

FIG. 17 is a block diagram of method 720, according to an embodiment. Diagram 720 shows a method for evaluating cybersecurity tools through a structured and adaptable testing process. Initially, the method involves simulating a network environment using synthetic data, which provides a controlled yet realistic setting for testing. This simulation is crucial as it forms the basis for subsequent evaluations.

The method then applies various testing conditions to the simulated environment. These conditions can include consistent conditions across evaluations to ensure comparability, realistic operational conditions that mimic actual network environments, specifically modified conditions tailored to test certain aspects of the cybersecurity tools, and noise-introduced conditions to assess tool robustness under disrupted or imperfect data scenarios. Other customized conditions can also be applied based on specific evaluation needs.

Following the application of these testing conditions, the method involves drawing evaluative conclusions based on the analysis of the evaluation results under two or more of these testing conditions. This analysis helps in understanding the effectiveness, efficiency, and reliability of the cybersecurity tools under different scenarios and conditions.

The overarching aim of this method is to provide an adaptable and standardized testing environment that facilitates the objective evaluation of cybersecurity tools under realistic conditions. This approach not only ensures that the tools are tested thoroughly but also that they are evaluated in a manner that closely replicates real-world operational scenarios, thereby enhancing the relevance and applicability of the evaluation results.

A similar method includes evaluating cybersecurity tools through a comprehensive and dynamic approach. It starts by simulating a network environment dynamically, ensuring that the simulation can adapt to various testing needs and conditions. Consistent testing conditions are applied across all evaluations to maintain standardization and comparability. Additionally, realistic operational conditions, such as network noise, errors, and uncertainties, are incorporated into the simulation to mimic real-world scenarios closely.

The simulation is further refined and adjusted based on feedback received from the evaluation results and external data, including both the actions of the cybersecurity tools and external threat data. This feedback mechanism allows the method to remain adaptable and responsive to new information, enhancing the accuracy and relevance of the testing environment.

The method also includes customizing the network environment to fit specific testing scenarios, which involves configuring modules to simulate different network architectures and threat models. In some implementations, the network environment is adjusted in real-time based on data received from the cybersecurity tools being tested. The testing conditions may also include industry-standard benchmarks or proprietary benchmarks, depending on the specific requirements of the evaluation.

Advanced features of the method include the use of a virtual reality interface for visualizing network attacks and defenses, and the implementation of the method on a decentralized blockchain platform for enhanced security and integrity. The simulation can include interconnected multi-network environments, providing a complex and comprehensive testing landscape.

Feedback processing within the method utilizes machine learning algorithms to automatically adjust simulation parameters, ensuring that the system continuously improves and adapitates based on the latest data. The method is also available as a service on a cloud platform, offering flexibility and accessibility to users.

Additionally, adaptive threat models can be generated using artificial intelligence, providing a cutting-edge approach to cybersecurity evaluation. The feedback mechanism includes an interface for manual adjustments by users, allowing for direct interaction and customization. Finally, the evaluation metrics provided by the method are both quantitative and qualitative, offering a detailed and nuanced assessment of cybersecurity tool performance.

A corresponding system provides for evaluating cybersecurity tools through a sophisticated and adaptable framework. It consists of several specialized modules that work in concert to simulate and assess various cybersecurity scenarios. The core of the system is the simulation device, which is configured to dynamically simulate a network environment. This device can adjust the network environment in real-time based on data received from the cybersecurity tools being tested, enhancing the relevance and responsiveness of the simulation.

A standardization device within the system applies consistent testing conditions across all evaluations, utilizing industry-standard benchmarks to ensure the effectiveness of the cybersecurity tools is measured against recognized criteria. Additionally, proprietary benchmarks developed specifically for the system can be applied, ensuring unique and consistent testing conditions.

The realism device of the system incorporates realistic operational conditions into the simulation, including variables such as network noise, errors, and uncertainties, to mimic real-world operational conditions. This device is capable of simulating interconnected multi-network environments, providing a comprehensive platform for evaluating tools in complex enterprise systems.

Feedback from the evaluations is processed by the feedback device, which adjusts the simulation based on real-time or periodic inputs from the evaluation results and external threat data. This device utilizes machine learning algorithms to automatically adjust the simulation parameters based on the evaluation outcomes, and includes an interface for manual adjustments by users, allowing for tailored testing processes according to specific needs.

The system also features a modular design that allows for customization of the network environment to fit specific testing scenarios. The modular components are configurable to simulate different types of network architectures and threat models. Additionally, the simulation device includes a virtual reality interface to visualize network attacks and defenses in a three-dimensional space, providing an immersive evaluation experience.

Implemented on a decentralized blockchain platform, the system enhances the security and transparency of the testing data. It is also hosted on a cloud platform, providing testing-as-a-service for remote users, which facilitates accessibility and convenience.

Finally, the system includes an evaluation metric device that provides both quantitative and qualitative assessments of the cybersecurity tools, offering a detailed and nuanced analysis of their performance. This comprehensive system provides an adaptable and standardized testing environment for objective evaluation of cybersecurity tools under realistic conditions.

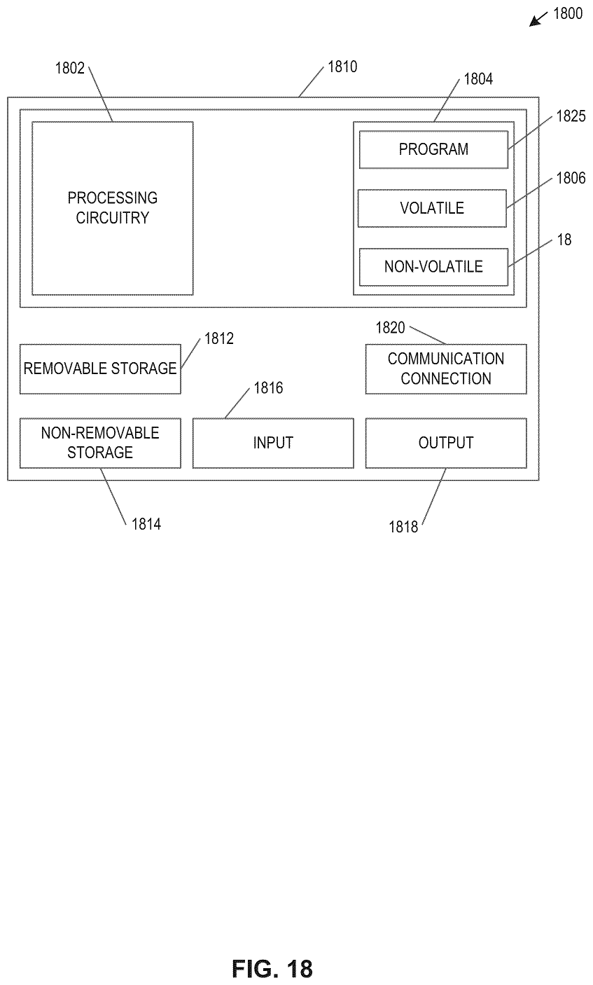

FIG. 18 is a block diagram of a computing device 1800, according to an embodiment. The performance of computing device 1800 may be improved by including one or more of the systems or methods for training artificial intelligence networks described herein. Computing device 1800 may include processing circuitry 1802 and memory 1804 that include instructions, which when executed by the processing circuitry 1802, configure the processing circuitry 1802 to obtain a plurality of input facts from the memory device, generate a plurality of target network output results based on the input facts, and train an expert system rule network. The training of the expert system rule network may include iteratively performing the steps of generating a training rule network, generating a plurality of training output results based on the training rule network and the plurality of input facts, and generating a revised rule network based on a comparison between the plurality of training output results and the plurality of target network output results. The revised rule network may include a plurality of network rules, each of the plurality of network rules having an associated defensible rule weighting, each defensible rule weighting identifying a probabilistic mapping of the plurality of input facts to an output fact generated by the expert system rule network.

In one embodiment, multiple such computing devices 1800 are used in a distributed network to implement multiple components in a transaction-based environment. An object-oriented, service-oriented, or other architecture may be used to implement such functions and communicate between the multiple systems and components. In some embodiments, the computing device of FIG. 18 is an example of a client device that may invoke methods described herein over a network. In some embodiments, the computing device of FIG. 18 is an example of one or more of the personal computer, smartphone, tablet, or various servers.

One example computing device in the form of a computer 1810, may include processing circuitry 1802, memory 1804, removable storage 1812, and non-removable storage 1814. Although the example computing device is illustrated and described as computer 1810, the computing device may be in different forms in different embodiments. For example, the computing device may instead be a smartphone, a tablet, or other computing device including the same or similar elements as illustrated and described with regard to FIG. 18. Further, although the various data storage elements are illustrated as part of the computer 1810, the storage may include cloud-based storage accessible via a network, such as the Internet.

Returning to the computer 1810, memory 1804 may include volatile memory 1806 and non-volatile memory 1808. Computer 1810 may include or have access to a computing environment that includes a variety of computer-readable media, such as volatile memory 1806 and non-volatile memory 1808, removable storage 1812 and non-removable storage 1814. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1810 may include or have access to a computing environment that includes input 1816, output 1818, and a communication connection 1820. The input 1816 may include one or more of a touchscreen, touchpad, mouse, keyboard, camera, and other input devices. The input 1816 may include a navigation sensor input, such as a GNSS receiver, a SOP receiver, an inertial sensor (e.g., accelerometers, gyroscopes), a local ranging sensor (e.g., LIDAR), an optical sensor (e.g., cameras), or other sensors. The computer may operate in a networked environment using a communication connection 1820 to connect to one or more remote computers, such as database servers, web servers, and another computing device. An example remote computer may include a personal computer (PC), server, router, network PC, a peer device or other common network node, or the like. The communication connection 1820 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing circuitry 1802 of the computer 1810. A hard drive (magnetic disk or solid state), CD-ROM, and RAM are some examples of articles including a non-transitory computer-readable medium. For example, various computer programs 1825 or apps, such as one or more applications and modules implementing one or more of the methods illustrated and described herein or an app or application that executes on a mobile device or is accessible via a web browser, may be stored on a non-transitory computer-readable medium.

In the detailed description and the claims, any reference to a module performing a computation refers to computing device or computing mechanism, such as a processor and memory shown in FIG. 18.

The apparatuses and methods described above may include or be included in high-speed computers, communication and signal processing circuitry, single-processor device or multi-processor modules, single embedded processors or multiple embedded processors, multi-core processors, message information switches, and application-specific modules including multilayer or multi-chip modules. Such apparatuses may further be included as sub-components within a variety of other apparatuses (e.g., electronic systems), such as televisions, cellular telephones, personal computers (e.g., laptop computers, desktop computers, handheld computers, etc.), tablets (e.g., tablet computers), workstations, radios, video players, audio players (e.g., MP3 (Motion Picture Experts Group, Audio Layer 3) players), vehicles, medical devices (e.g., heart monitors, blood pressure monitors, etc.), set top boxes, and others.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, a list of items joined by the term “at least one of” may mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A may include a single element or multiple elements. Item B may include a single element or multiple elements. Item C may include a single element or multiple elements.

In the detailed description and the claims, a list of items joined by the term “one of” may mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A may include a single element or multiple elements. Item B may include a single element or multiple elements. Item C may include a single element or multiple elements.

### Additional Notes and Examples

Example 1 is a method for conducting cybersecurity analysis, the method comprising: model creation; model analysis; and model reporting.

In Example 2, the subject matter of Example 1 includes, generating virtual representations based on data from a plurality of operational systems; and using a simulation environment to simulate cyber-attacks on the virtual representations without impacting a plurality of physical operational systems or assess the virtual representations for cybersecurity vulnerabilities based on their characteristics.

In Example 3, the subject matter of Example 2 includes, at least one of: modifying, at a feedback device, at least one of the virtual representations or simulation parameters based on outcomes from previous simulations to enhance subsequent simulation accuracy and effectiveness; limiting, at a filtering device, what results are analyzed; or limiting, at the filtering device, what results are presented to a user.

In Example 4, the subject matter of Examples 2-3 includes, generating, using an automated data collection mechanism, a plurality of virtual representations of systems based on scans of the plurality of operational systems and providing this data in a machine-readable format, where the automated data collection mechanism directs a plurality of pieces of input data at systems to identify potential vulnerabilities; wherein the input data is at least one of: generated using a random or pseudorandom generation process, generated based on configuration files, generated based on system analysis, generated based on adaptive analysis, or generated using another method; wherein the automated data collection mechanism utilizes an interface mechanism to communicate with each system; wherein the automated data collection mechanism is used to assess multiple types of systems.

In Example 5, the subject matter of Examples 1-4 includes, at least one of: performing security assessment without causing operational downtime; performing security assessment without causing significant performance degradation; analyzing data to identify potential future security vulnerabilities and attack pathways; analyzing data continuously or near-continuously to identify security vulnerabilities and attack pathways; or leveraging recognized security assessment frameworks to enhance an identification and analysis of vulnerabilities and attack pathways.

In Example 6, the subject matter of Examples 1-5 includes, at least one of: operating a plurality of computational modules to detect and analyze cybersecurity threats; operating a plurality of computational modules autonomously to detect, analyze, and respond to cybersecurity threats; operating a plurality of computational modules to analyze cybersecurity threats where data exchange among the modules is facilitated via a communication network; operating a plurality of computational modules to analyze cybersecurity threats wherein at least one device executes a search algorithm, such as an iterative deepening search algorithm, to evaluate potential vulnerabilities and attack paths; or operating a plurality of computational modules to analyze cybersecurity threats wherein a continuous operation of an infrastructure is maintained during the cybersecurity analysis.

In Example 7, the subject matter of Examples 1-6 includes, at least one of: non-invasively collecting data from systems, using data collected from systems, or providing an interface for a user to enter data; wherein the systems are at least one of: operational technology systems, functional technology systems, information technology systems, hybrid systems, other systems; analyzing the collected data using algorithms to at least one of: detect potential threats, detect actual threats, or detect vulnerabilities; at least one of: calculating risk scores based on the analysis, updating risk scores based on the analysis, identifying vulnerabilities based on the analysis, identifying risks based on the analysis, identifying attack paths based on the analysis or providing insights to system operators.

In Example 8, the subject matter of Examples 1-7 includes, utilizing multiple computer processing threads to perform this analysis; utilizing at least one of: synchronous or asynchronous communications between processors, two or more processing threads within a common physical processor, two or more processors located within a common computer system, processors located within two or more computer systems, network communications between two or more computing systems or error correction of network communications.

In Example 9, the subject matter of Examples 1-8 includes, wherein this method is used to perform automated penetration testing of network systems further including: collecting and analyzing data from a network; autonomously making decisions based on the analyzed data; executing penetration testing actions based on these decisions; receiving and processing feedback from the executed actions in real-time or near real-time; at least one of: making a security recommendation to a user, correcting a vulnerability, taking an action based on the feedback to enhance an identification of vulnerabilities, taking an action based on the feedback to enhance a mapping of vulnerabilities, taking an action based on the feedback to enhance an exploitation of vulnerabilities, or adjusting subsequent penetration testing activities.

In Example 10, the subject matter of Examples 1-9 includes, wherein this method is used to evaluate cybersecurity tools, comprising: simulating a network environment using synthetic data; applying testing conditions including at least one of: consistent conditions across evaluations, realistic operational conditions, specifically modified conditions, noise-introduced conditions, other conditions; drawing evaluative conclusions based on analysis of the evaluation results under two or more testing conditions; wherein the method provides an adaptable and standardized testing environment for an objective evaluation of cybersecurity tools under realistic conditions.

In Example 11, the subject matter of Examples 1-10 includes, applying at least one heuristic, wherein the at least one heuristic includes at least one of: a path termination heuristic that stops processing when an identified condition is met; or a rule running heuristic that stops processing when a specified number of rules have been run.

In Example 12, the subject matter of Examples 1-11 includes, at least one of: incorporating a function that allows a user to specify a common property that is not assessed; incorporating a function that allows a user to specify a common property that is not assessed if it is missing during processing; incorporating a function that allows a user to specify a fact that is not assessed; incorporating a function that allows a user to specify a fact that is not assessed if it is missing during processing; incorporating a function that allows a user to select what rules are run during processing; or incorporating a function that allows a user to select whether post-condition facts are created.

In Example 13, the subject matter of Examples 1-12 includes, aggregating data from a plurality of sources; converting the aggregated data into a processing format; analyzing the aggregated data using processing algorithms to identify potential threats.

In Example 14, the subject matter of Example 13 includes, calculating risk scores based on the analysis; at least one of: implementing security measures based on the risk scores or recommending security measures based on the risk scores; updating the risk scores and security measures in real-time based on data inputs; wherein: the data relates to at least one of: an organization's employees, an organization's contractors, an organization's vendor staff, an organization's volunteers, an organization's affiliates' workforce, family members of an organization's workforce, associates of an organization's workforce, communications of an organization's workforce, activities of an organization's workforce, interactions between a members of an organization's workforce or influences on an organization's workforce; and the organization's workforce includes at least one of employees, contractors, or vendor staff.

In Example 15, the subject matter of Examples 13-14 includes, wherein: the data relates to at least one of: an organization, an organization's business partners, an organization's suppliers, an organization's customers, an organization's affiliates or an organization's extended workforce; and workforce includes at least one of a workforce of organization, a workforce of business partners, a workforce of suppliers, a workforce of customers, or a workforce of affiliates.

Example 16 is a method for conducting computer processing, the method comprising: at least one of automated decision making, decision recommendation, or decision support based on data elements and rule elements.

In Example 17, the subject matter of Example 16 includes, wherein the method includes providing a plurality of rule, fact and property objects, the method further including: providing a visualization of a network; including at least one of: coloration of network components to indicate status, coloration of network components to indicate a number of traversals of the network component, other coloration of network components, labeling of network components, marking of network components, identification of network components, altering visual organization of the network components, saving the visualization as a graphics file, saving the visualization as a vector file, saving the visualization as a hypertext markup file, or printing the visualization; wherein the method allows at least one of: enhanced human understandability of the network, identification of network features, identification of network limitations, identification of network anomalies, identification of network changes, identification of network vulnerabilities, identification of processing requirements, identification of network speed, identification of attack speed, or identification of network deviations from a standard.

In Example 18, the subject matter of Examples 16-17 includes, a method for enhancing decision-making through data verification and updating, comprising: verifying an accuracy of data elements from external-to-system sources; dynamically updating system data elements based on a set of verification results; utilizing the updated data elements in decision-making processes to improve operational decisions; conducting verification of data elements based on one of: access to the data element, elapsed time, lack of previous verification, a number of accesses of a data element, expiration of the data element, or other verification trigger.

In Example 19, the subject matter of Examples 16-18 includes, utilizing multiple computer processing threads to perform this analysis; utilizing at least one of: synchronous or asynchronous communications between processors, two or more processing threads within a common physical processor, two or more processors located within a common computer system, processors located within two or more computer systems, network communications between two or more computing systems or error correction of network communications.

In Example 20, the subject matter of Examples 16-19 includes, wherein the method includes providing two or more rule, fact and property objects, further including: at least one of: grouping related objects into organizational units, grouping related objects into organizational units and establishing relationships between said organizational units through a connection mechanism or grouping related objects into organizational units and configuring the organizational units to be nested; wherein groupings, nestings, and relationships represent various types of associations including organizational, hierarchical, physical, temporal, geospatial, and spatial relationships and relationships can be at least one of: directional, non-directional, bidirectional or undefined.

In Example 21, the subject matter of Examples 16-20 includes, wherein the method includes providing a plurality of rule, fact and property objects, further including: at least one of: providing alternate objects where the alternate object represents another configuration of the object; providing alternate objects where the alternate object represents another configuration of the object at a different time in processing; providing alternate objects where the alternate object represents another configuration of the object under a different object network configuration; providing alternate objects where the objects are stored as a path that indicates how changes to the network were made; providing alternate objects where the alternate object represents another configuration of the object at a different time in processing where the objects are stored as a path that indicates how changes to the network were made; providing alternate objects where the alternate object represents another configuration of the object under a different object network configuration where the objects are stored as a path that indicates how changes to the network were made; providing alternate objects where the alternate object represents another configuration of the object where the objects are stored as a path that stores an order of object changes; or providing alternate objects that are identified as a most recent alternate objects.

In Example 22, the subject matter of Examples 16-21 includes, wherein the method includes providing a plurality of rule, fact, and property objects, further including at least one of: defining a set of common properties to standardize at least one of: data interpretation, data use or data manipulation across multiple components of an object network; defining a set of common properties where the common properties are identified by a common property identifier; defining facts that are associated with a common property identifier to indicate that they are of a common property type; defining a set of generic rules that utilize standardized objects as at least one of: their inputs or their outputs; defining a set of generic rules that utilize common properties as at least one of: their inputs or their outputs; defining environment facts that can be used throughout a network; defining rules that can alter a value of a plurality of facts or all facts of a common property type, allowing reuse of rules throughout a network; allowing reuse of properties throughout a network.

Example 23 is a method for identifying vulnerabilities and defects in source code, comprising: detecting vulnerabilities using a plurality of computational modules; converting source code from one or more programming languages into a common intermediate language; analyzing source code in a common intermediate language; at least one of: identifying vulnerabilities using a machine learning algorithm, generating targeted corrections using a machine learning algorithm, applying targeted corrections back to an original source code, or identifying vulnerable areas in the original source code.

Example 24 is at least one machine-readable medium including instructions that, when executed by processing circuitry, cause the processing circuitry to perform operations to implement of any of Examples 1-23.

Example 25 is an apparatus comprising means to implement of any of Examples 1-23.

Example 26 is a system to implement of any of Examples 1-23.

Example 27 is a method to implement of any of Examples 1-23.

The subject matter of any Examples above may be combined in any combination.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A method for conducting cybersecurity analysis, the method comprising:
model creation;
model analysis; and
model reporting.

2. The method of claim 1, further including:
generating virtual representations based on data from a plurality of operational systems; and
using a simulation environment to:
simulate cyber-attacks on the virtual representations without impacting the physical operational systems; or
assess the virtual representations for cybersecurity vulnerabilities based on their characteristics.

3. The method of claim 2, further including at least one of:
modifying, at a feedback mechanism, at least one of the virtual representations or simulation parameters based on outcomes from previous simulations to enhance subsequent simulation accuracy and effectiveness;
limiting, at an analysis filtering mechanism, what results are analyzed; or
limiting, at presentation filtering mechanism, what results are presented to a user.

4. The method of claim 2, further including:
generating, using an automated data collection mechanism, a plurality of virtual representations of systems based on scans of the plurality of operational systems and providing this data in a machine-readable format, where the automated data collection mechanism directs a plurality of pieces of input data at systems to identify potential vulnerabilities;
wherein the input data is at least one of: generated using a random or pseudorandom generation process, generated based on configuration files, generated based on system analysis, generated based on adaptive analysis, or generated using another method;
wherein the automated data collection mechanism utilizes an interface mechanism to communicate with each system;
wherein the automated data collection mechanism assesses multiple types of systems.

5. The method of claim 1, further including at least one of:
performing security assessment without causing operational downtime;
performing security assessment without causing significant performance degradation;
analyzing data to identify potential future security vulnerabilities and attack pathways;
analyzing data continuously or near-continuously to identify security vulnerabilities and attack pathways; or
leveraging recognized security assessment frameworks to enhance an identification and analysis of vulnerabilities and attack pathways.

6. The method of claim 1, further including at least one of:
operating a plurality of computational modules to detect and analyze cybersecurity threats;
operating a plurality of computational modules autonomously to detect, analyze, and respond to cybersecurity threats;
operating a plurality of computational modules to analyze cybersecurity threats where data exchange among the modules is facilitated via a communication network;
operating a plurality of computational modules to analyze cybersecurity threats wherein at least one device executes a search algorithm, such as an iterative deepening search algorithm, to evaluate potential vulnerabilities and attack paths; or
operating a plurality of computational modules to analyze cybersecurity threats wherein a continuous operation of an infrastructure is maintained during the cybersecurity analysis.

7. The method of claim 1, further including:
at least one of: non-invasively collecting data from systems, using data collected from systems, or providing an interface for a user to enter data;
wherein the systems are at least one of: operational technology systems, functional technology systems, information technology systems, hybrid systems, other systems;
analyzing the collected data using algorithms to at least one of: detect potential threats, detect actual threats, or detect vulnerabilities;
at least one of: calculating risk scores based on the analysis, updating risk scores based on the analysis, identifying vulnerabilities based on the analysis, identifying risks based on the analysis, identifying attack paths based on the analysis or providing insights to system operators.

8. The method of claim 1, further including:
utilizing multiple computer processing threads to perform this analysis;
utilizing at least one of: synchronous or asynchronous communications between processors, two or more processing threads within a common physical processor, two or more processors located within a common computer system, processors located within two or more computer systems, network communications between two or more computing systems or error correction of network communications.

9. The method of claim 1, wherein this method is used to perform automated penetration testing of network systems further including:
collecting and analyzing data from a network;
autonomously making decisions based on the analyzed data;
executing penetration testing actions based on these decisions;
receiving and processing feedback from the executed actions in real-time or near real-time;
at least one of: making a security recommendation to a user, correcting a vulnerability, taking an action based on the feedback to enhance an identification of vulnerabilities, taking an action based on the feedback to enhance a mapping of vulnerabilities, taking an action based on the feedback to enhance an exploitation of vulnerabilities, or adjusting subsequent penetration testing activities.

10. The method of claim 1, wherein this method is used to evaluate cybersecurity tools, comprising:
simulating a network environment using synthetic data;
applying testing conditions including at least one of: consistent conditions across evaluations, realistic operational conditions, specifically modified conditions, noise-introduced conditions, other conditions;
drawing evaluative conclusions based on analysis of the evaluation results under two or more testing conditions;
wherein the method provides an adaptable and standardized testing environment for an objective evaluation of cybersecurity tools under realistic conditions.

11. The method of claim 1, further including applying at least one heuristic, wherein the at least one heuristic includes at least one of:
a path termination heuristic that stops processing when an identified condition is met; or
a rule running heuristic that stops processing when a specified number of rules have been run.

12. The method of claim 1, further including at least one of:
incorporating a function that allows a user to specify a common property that is not assessed;
incorporating a function that allows a user to specify a common property that is not assessed if it is missing during processing;
incorporating a function that allows a user to specify a fact that is not assessed;
incorporating a function that allows a user to specify a fact that is not assessed if it is missing during processing;
incorporating a function that allows a user to select what rules are run during processing; or
incorporating a function that allows a user to select whether post-condition facts are created.

13. The method of claim 1, further including:
aggregating data from a plurality of sources;
converting the aggregated data into a processing format;
analyzing the aggregated data using processing algorithms to identify potential threats.

14. The method of claim 13, further including:
calculating risk scores based on the analysis;
at least one of: implementing security measures based on the risk scores or recommending security measures based on the risk scores;
updating the risk scores and security measures in real-time based on data inputs;
wherein:
the data relates to at least one of: an organization's employees, an organization's contractors, an organization's vendor staff, an organization's volunteers, an organization's affiliates' workforce, family members of an organization's workforce, associates of an organization's workforce, communications of an organization's workforce, activities of an organization's workforce, interactions between members of an organization's workforce or influences on an organization's workforce; and
the organization's workforce includes at least one of employees, contractors, or vendor staff.

15. The method of claim 13, wherein:
the data relates to at least one of: an organization, an organization's business partners, an organization's suppliers, an organization's customers, an organization's affiliates or an organization's extended workforce;
and workforce includes at least one of a workforce of organization, a workforce of business partners, a workforce of suppliers, a workforce of customers, or a workforce of affiliates.

16. A method for conducting computer processing, the method comprising:
at least one of automated decision making, decision recommendation, or decision support based on data elements and rule elements.

17. The method of claim 16, wherein the method includes providing a plurality of rule, fact and property objects, the method further including:
providing a visualization of a network;
including at least one of: coloration of network components to indicate status, coloration of network components to indicate a number of traversals of the network component, other coloration of network components, labeling of network components, marking of network components, identification of network components, altering the visual organization of the network components, saving the visualization as a graphics file, saving the visualization as a vector file, saving the visualization as a hypertext markup file, or printing the visualization;
wherein the method allows at least one of: enhanced human understandability of the network, identification of network features, identification of network limitations, identification of network anomalies, identification of network changes, identification of network vulnerabilities, identification of processing requirements, identification of network speed, identification of attack speed, or identification of network deviations from a standard.

18. The method of claim 16, further including a method for enhancing decision-making through data verification and updating, comprising:
verifying a data elements accuracy from external-to-system sources;
dynamically updating system data elements based on a set of verification results;
utilizing the updated data elements in decision-making processes to improve operational decisions;
conducting verification of data elements based on one of: access to the data element, elapsed time, lack of previous verification, a number of accesses of a data element, expiration of the data element, or other verification trigger.

19. The method of claim 16, further including:
utilizing multiple computer processing threads to perform this analysis;
utilizing at least one of: synchronous or asynchronous communications between processors, two or more processing threads within a common physical processor, two or more processors located within a common computer system, processors located within two or more computer systems, network communications between two or more computing systems or error correction of network communications.

20. The method of claim 16, wherein the method includes providing two or more rule, fact and property objects, further including:
at least one of: grouping related objects into organizational units, grouping related objects into organizational units and establishing relationships between said organizational units through a connection mechanism or grouping related objects into organizational units and configuring the organizational units to be nested;
wherein groupings, nestings, and relationships represent various types of associations including organizational, hierarchical, physical, temporal, geospatial, and spatial relationships and relationships can be at least one of: directional, non-directional, bidirectional or undefined.

21. The method of claim 16, wherein the method includes providing a plurality of rule, fact and property objects, further including:
at least one of: providing alternate objects where the alternate object represents another configuration of the object;
providing alternate objects where the alternate object represents another configuration of the object at a different time in processing;
providing alternate objects where the alternate object represents another configuration of the object under a different object network configuration;
providing alternate objects where the objects are stored as a path that indicates how changes to the network were made;
providing alternate objects where the alternate object represents another configuration of the object at a different time in processing where the objects are stored as a path that indicates how changes to the network were made;
providing alternate objects where the alternate object represents another configuration of the object under a different object network configuration where the objects are stored as a path that indicates how changes to the network were made;
providing alternate objects where the alternate object represents another configuration of the object where the objects are stored as a path that stores an order of object changes; or
providing alternate objects that are identified as most recent alternate objects.

22. The method of claim 16, wherein the method includes providing a plurality of rule, fact, and property objects, further including at least one of:
defining a set of common properties to standardize at least one of: data interpretation, data use or data manipulation across multiple components of an object network;
defining a set of common properties where the common properties are identified by a common property identifier;
defining facts that are associated with a common property identifier to indicate that they are of a common property type;
defining a set of generic rules that utilize standardized objects as at least one of: their inputs or their outputs;
defining a set of generic rules that utilize common properties as at least one of: their inputs or their outputs;
defining environment facts that can be used throughout a network;
defining rules that can alter a value of a plurality of facts or all facts of a common property type,
allowing reuse of rules throughout a network;
allowing reuse of properties throughout a network.

23. A method for identifying vulnerabilities and defects in source code, comprising:
detecting vulnerabilities using a plurality of computational modules;
converting source code from one or more programming languages into a common intermediate language;
analyzing source code in a common intermediate language;
at least one of: identifying vulnerabilities using a machine learning algorithm, generating targeted corrections using a machine learning algorithm, applying targeted corrections back to an original source code, or identifying vulnerable areas in the original source code.
